(19) United States
(12) Patent Application Publication
(10) Pub. No.: US 2011/0164487 A1
(43) Pub. Date: Jul. 7, 2011

(54) INFORMATION RECORDING/REPRODUCING DEVICE AND INFORMATION RECORDING/ REPRODUCING METHOD

(76) Inventors: Isao Kobayashi, Osaka (JP); Kohei Nakata, Nara (JP)

(21) Appl. No.: 13/062,371

(22) PCT Filed: Feb. 12, 2010
(86) PCT No.: PCT/JP2010/000868

§ 371 Date: Mar. 4, 2011

(30) Foreign Application Priority Data
Feb. 12, 2009 (JP) 2009-030510

(51) Int. Cl. G11B 20/10; G11B 20/02; G11B 7/135

(52) U.S. Cl. 369/59.21; 369/174; 369/109.01; 369/112.23; G9B/20.004; G9B/7.112; G9B/20.009

(57) ABSTRACT

A writing condition adjusting apparatus according to the present invention adjusts a writing condition using first and second recording patterns. The first recording pattern is used to adjust a writing condition for recording marks and spaces, of which the lengths are equal to or longer than a predetermined recording length, while the second recording pattern is used to adjust a writing condition for recording marks and spaces, of which the lengths are shorter than the predetermined recording length by one recording unit length. If it has been decided that the writing condition that has once been determined by making the write adjustment on such marks that are shorter by one recording unit length needs to be adjusted again, a signal index value that has been defined based on the first recording pattern is set to be a target value. The writing condition for recording marks, which are shorter by one recording unit length, is adjusted again so that a signal index value associated with those marks that are shorter by one recording unit length becomes as close to the target value as possible.

### TECHNICAL FIELD

The present invention relates to an information reading/writing apparatus and method for getting a high-density write operation done on an information recording medium that has an information recording plane, on which information can be written optically.

### BACKGROUND ART

Various kinds of recordable information recording media are currently available to record audiovisual data or to store PC data thereon. Examples of those information recording media include optical discs such as CDs and DVDs. And BD (Blu-ray Discs), of which the capacity is big enough to store even high-definition video of digital broadcasting, for example, have also been put on the market just recently.

Generally speaking, in order to prevent the quality of a signal to be written on an information recording medium from being debased due to some variation to be caused between lots of information recording media being manufactured or between individual devices (or recorders/players) in terms of laser wavelength or the sensitivity of photodetectors, an information recording medium recorder/player usually adjusts a writing condition while the information recording medium is being loaded or unloaded into/from the recorder/player, for example. As used herein, “to adjust a writing condition” refers to a kind of control operation for optimizing the recording power and/or write pulse settings in order to write information properly and ensure good signal quality for the user data written. As one of those writing condition adjustment methods, a technique for optimizing a write pulse shape by maximum likelihood decoding has been proposed recently (see Patent Document No. 1, for example). PRML (partial response maximum likelihood) is an exemplary method for processing a read signal by maximum likelihood decoding.

According to Patent Document No. 1, using a bit string that is a result of decoding (which will be referred to herein as a “correct bit string”) and a bit string with a most common error in which just one bit of the correct bit string has shifted (which will be referred to herein as an “erroneous bit string”), Euclidean distances between the read signal and those two bit strings are calculated, thereby estimating an adaptively equalized read signal and detecting the direction and amount of edge shift on each patterns. And adaptive write parameters, which are classified by the lengths of preceding and following spaces and the mark length to compile a table, are optimized according to the direction and amount of edge shift on each patterns.

Hereinafter, a write laser pulse waveform will be described briefly. FIG. 16 illustrates a write pulse waveform and its associated recording powers.

Portion (a) of FIG. 16 shows one period Tw of a channel clock signal, which is used as a reference signal for generating write data. That one period Tw determines the time intervals between the recorded marks and spaces of the NRZI (non-return to zero inverting) signal, which is a kind of write signal, as shown in portion (b) of FIG. 16, which illustrates a part of an exemplary NRZI signal with a recording pattern consisting of a 2T mark, a 2T space and a 4T mark.

Portion (c) of FIG. 16 illustrates a multi-pulse train of a laser beam that produces a recorded mark. The recording powers Pw of the multi-pulse train include a peak power (Pp) 201 with a heating effect, which is needed when a recorded mark is formed, a bottom power (Pb) 202 and a cooling power (Pc) 203 with a cooling effect, and a space power (Ps) 204, which is recording power for a space portion. The peak power (Pp) 201, bottom power (Pb) 202, cooling power (Pc) 203 and space power (ps) 204 are defined by reference to an extinction level 205, which is detected when the laser beam is extinct.

It should be noted that the bottom power (Pb) 202 and the cooling power (Pc) 203 could be roughly equal recording powers. But in order to adjust the quantity of heat at the end of a recorded mark, the cooling power (Pc) 203 could be set to have a different value from the bottom power (Pb) 202. On the other hand, as there is no need to form any recorded mark for space portions, the space power (Ps) 204 is usually a low recording power, which may be as low as a readout power or the bottom power, for example. In a rewritable optical disc (such as a DVD-RAM or a BD-RE), however, a space portion should be formed by erasing an existent recorded mark, and therefore, the space power (Ps) 204 is sometimes set to be a relatively high recording power. Also, in a write-once optical disc (such as a DVD-R or a BD-R), the space power (Ps) 204 could be set to be a relatively high recording power as a preheat power to prepare for forming the next recorded mark. Even in those cases, however, the space power (Ps) 204 is never set to be higher than the peak power (Pp) 201.

As for pulse widths, the pulse width Ttop of the first pulse is set for a write signal representing a 2T, 3T or 4T or longer mark. In a multi-pulse train representing a 3T or longer mark, the pulse widths Tmp of pulses that follow the Ttop one are supposed to be constant, and the pulse width Tmp of the last pulse is set as the last pulse width Tlp. Also, as for each recorded mark length, a writing starting point offset dTtop for adjusting the starting point of a recorded mark and writing end point offset dTs for adjusting the end point are set. A type of write compensation in which the write parameters (such as dTtop) of a write pulse are changed according to the length of either a preceding space or a following space is generally called a “space compensation”.

Laser emission settings for write operation, including the respective recording power values and pulse widths of the multi-pulse train described above, are stored inside of an optical disc. That is why if a recording layer of the optical disc can be irradiated with a laser beam by reproducing the recording powers and pulse widths of the multi-pulse train stored inside of the optical disc, recorded marks such as the ones shown in portion (d) of FIG. 16 can be formed.

The shapes of write pulses include not only the multi-pulse waveform shown in portion (c) of FIG. 16 but also the respective write pulse shapes shown in FIG. 17 as well. Specifically, FIGS. 17(a), 17(b) and 17(c) illustrate a mono-pulse waveform, an L-pulse waveform, and a castle pulse waveform, respectively. The quantity of heat to be stored in the recording layer of the optical disc varies depending on which of these write pulse waveforms is adopted. In this case, a write pulse waveform is selected according to the property of the recording layer in order to make the best recorded mark.

Hereinafter, it will be described with reference to FIG. 18 how a writing controller performs a write pulse control.

The information that has been retrieved from an information recording medium 1 is obtained by an optical head as an analog read signal, which is amplified by a preamplifier section 3, AC-coupled and then supplied to an AGC section 4. In response, the AGC section 4 adjusts the amplitude of the signal so that the output of a waveform equalizing section 5 that follows the AGC section 4 will have constant amplitude. After having had its amplitude adjusted, the analog read signal has its waveform shaped by the waveform equalizing section 5 and then supplied to an A/D converting section 6. In response to a read clock signal supplied from a PLL section 7, the A/D converting section 6 samples the analog read signal. The PLL section 7 extracts a read clock signal from the digital read signal that has been sampled by the A/D converting section 6.

The digital read signal that has been generated by being sampled by the A/D converting section 6 is input to a PR equalization section 8, which adjusts the frequency of the digital read signal so that the frequency characteristic of the digital read signal during write and read operations is as expected by a maximum likelihood decoding section 9 (e.g., has a PR (1, 2, 2, 1) equalization characteristic). The maximum likelihood decoding section 9 performs maximum likelihood decoding on the digital read signal, which has been supplied from the PR equalization section 8 after having had its waveform shaped, thereby generating a binarized signal. The maximum likelihood decoding section 9 may be a Viterbi decoder, for example. A read signal processing technique that uses the PR equalization section 8 and the maximum likelihood decoding section 9 in combination is a so-called “PRMML method”.

An edge shift detecting section 10 receives not only the waveform-shaped digital read signal from the PR equalization section 8 but also the binarized signal from the maximum likelihood decoding section 9 as well. Specifically, the edge shift detecting section 10 detects the state transition pattern by the binarized signal and also determines the reliability of the decoding result based on the result of detection and branch metric. Also, the edge shift detecting section 10 assigns the reliability to various recorded mark leading and trailing edge patterns based on the binarized signal, thereby obtaining the deviations of the write compensation parameters from their optimum values. Hereinafter, the deviation to be detected by maximum likelihood decoding will be referred to herein as an “edge shift”.

In accordance with an instruction that information be changed, an information writing control section 15 changes write parameters, which have been defined in advance so that their settings are changeable, according to the amount of edge shift on each patterns. Those write parameters with adjustable settings have been defined in advance and may be a writing starting point offset dTtop at a leading edge portion of a recorded mark and a writing end point offset dTs at a trailing edge portion. The information writing control section 15 changes the write parameters by reference to the tables of write parameters shown in FIG. 19, which shows how a space compensation can get done on the write parameters. Specifically, FIG. 19(a) shows the relations between the length of a recorded mark and its preceding spaces at the leading edge, while FIG. 19(b) shows the relations between the length of a recorded mark and its following spaces at the trailing edge.

As for the recorded marks M(i), the preceding spaces S(i−1) and the following spaces S(i+1) shown in FIG. 19, M represents a recorded mark, S represents a space, and the time series of an arbitrary recorded mark or space is identified by “i”. A recorded mark with the write parameters shown in FIG. 19 is identified by M(i). Thus, the space that precedes the recorded mark M(i) is S(i−1) and the space that follows the recorded mark M(i) is S(i+1). That is why the pattern 3Ts4Tm at the leading edge shown in FIG. 19 satisfies S(i−1)=3T and M (i)=4T. On the other hand, the pattern 3Tm2Ts at the trailing edge satisfies M(i)==3T and S(i+1)=2T. Furthermore, in FIG. 19, there are 32 different write parameters overall for the leading and trailing edges.

To make adjustment on the leading edge of a 4T recorded mark, which is preceded by a 3T space, for example, the information writing control section 15 changes the write parameters (e.g., dTtop) of 3Ts4Tm. On the other hand, to make adjustment on the trailing edge of a 3T recorded mark, which is followed by a 2T space, for example, the information writing control section 15 changes the write parameters (e.g., dTs) of 3Tm2Ts.

A recording pattern generating section 11 generates an NRZI signal to be a recording pattern based on the write data supplied. A write compensation section 12 generates a write pulse train based on the write parameters that have been changed by the information writing control section 15 and in response to the NRZI signal. A recording power setting section 14 sets the peak power Pp, the bottom power Pb and other recording power levels. A laser driving section 13 controls the laser emission operation by the optical head 2 using the write pulse train and the recording power that has been set by the recording power setting section 14.

In this manner, a read/write operation is performed on the information recording medium 1 and the write pulse shape is controlled so as to reduce the amount of the edge shift.

### CITATION LIST

### Patent Literature

Patent Document No. 1: Japanese Patent Application Laid-Open Publication No. 2004-335079
Patent Document No. 2: Pamphlet of PCT International Application Publication WO 2006/112277
Patent Document No. 3: Japanese Patent Application Laid-Open Publication No. 2005-251391

### Non-Patent Literature

Non-Patent Document No. 1: The Illustrated Blu-ray Disc Reader, published by Ohmsha, Ltd.

### SUMMARY OF INVENTION

### Technical Problem

If the storage densities of information recording media were further increased, the intersymbol interference and the decrease in SNR would be aggravated. Even so, according to Non-Patent Document No. 1, the system margin of an information reading/writing apparatus could be maintained by adopting a PRML method of a higher order. For example, if the given 12 cm optical disc medium has a storage capacity of 25 GB per recording layer, the system margin can be maintained by adopting the PRML 1221 ML method. Also, according to Non-Patent Document No. 1, if the storage capacity per recording layer is 33.4 GB, then the PR 12221 ML method should be adopted. It is expected that the higher the storage densities of information recording media, the higher the order of the PRML method to adopt would tend to be as described above.

FIG. 20 illustrates exemplary waveforms of read signals to be generated when the same write data is stored at mutually different densities. Specifically, portion (a) of FIG. 20 shows the write data. Portion (b) of FIG. 20 shows the waveform of a read signal in a situation where the lengths of the shortest recorded marks and spaces are still way under the optical diffraction limit. And portion (c) of FIG. 20 shows the waveform of a read signal in a situation where the lengths of the shortest recorded marks and spaces are at or beyond the optical diffraction limit.

In the write data shown in portion (a) of FIG. 20, Interval A is an interval in which longest recorded marks and spaces appear consecutively. Interval B is an interval in which second shortest recorded marks and spaces appear consecutively. And Interval C is an interval in which the shortest marks and spaces appear consecutively. A modulation code for use in a BD is a 1-7 PP modulation code, which belongs to the group of RLL (1, 7) modulation codes and which includes recorded marks and spaces with lengths of 2T through 8T. That is why Interval A is a signal interval with a series of 8T marks and spaces, Interval B is a signal interval with a series of 3T marks and spaces, and Interval C is a signal interval with a series of 2T marks and spaces.

The read signal waveform shown in portion (b) of FIG. 20 is a signal waveform obtained by reading or writing the write data shown in portion (a) of FIG. 20 from/on a retailed BD-R with a storage capacity of 25 GB at a storage density of 25 GB per layer.

On the other hand, the read signal waveform shown in portion (c) of FIG. 20 is a signal waveform obtained by reading or writing the write data shown in portion (a) of FIG. 20 from/on a retailed BD-R with a storage capacity of 25 GB at a storage density of 33.4 GB per layer. In this case, the recorder/player was used under the same optical conditions, including the wavelength of the laser beam and the numerical aperture (NA) of the lens, as in the situation shown in portion (b) of FIG. 20.

Compared to the read signal shown in portion (b) of FIG. 20, the read signal shown in portion (c) of FIG. 20 is affected by intersymbol interference much more significantly. That is why when the shortest recorded marks and spaces are read in Interval C, the resultant signal waveform has no amplitude. Likewise, the read signal, obtained by reading the second shortest recorded marks and spaces in Interval B, also has decreased amplitude. When the longest recorded marks and spaces are read in Interval A, however, a high-order harmonic signal range is affected by the high-density recording. Therefore, the almost rectangular signal waveform shown in portion (b) of FIG. 20 is somewhat closer to a sinusoidal waveform in shown in portion (c) of FIG. 20. Nevertheless, the amplitude of the read signal has hardly changed.

Even if a write operation has been performed with so high a density that the read signal representing the shortest recorded mark or space has zero amplitude, a write pulse adjustment by PRML method is still effective. When a read signal is processed by the PRML method, a signal that has been read out from an information recording medium is decoded into a binarized signal by PR equalization and maximum likelihood decoding process, and the signal level that the read signal should have is estimated based on the binarized signal. For that purpose, the write pulse settings are optimized so that the waveform of the signal that has been read from the information recording medium has its original signal level.

However, as already described with reference to FIG. 20, if the storage density is increased, the amplitude of the read signal representing a short recorded mark or space decreases more significantly than that of the read signal representing the longest recorded mark or space. The shorter the recorded marks and spaces that are combined to form a recording pattern, the more significant that decrease in amplitude will be. The same can be said about how much the shape of a recorded mark changes with a variation in some writing condition such as the recording power or write pulse (i.e., the write sensitivity). That is to say, the shorter the recorded mark, the higher the write sensitivity will be. This is because recorded marks are so small that the spread of a mark will easily change both back and forth and to the right and to the left. That is why if the shortest marks are recorded with their writing condition significantly deviated from their initial value when the write pulses start to be adjusted, then those marks recorded will be neither correctly decoded nor recognized to be shortest marks and may be detected erroneously to be different write signals. In that case, the exact amount of edge shift could not be detected from the edges at which the write adjustment is supposed to be done, and an erroneous amount of edge shift could be detected from a wrong edge.

FIG. 21 illustrates a situation where the size of the shortest recorded marks (e.g., 2T marks in this example) has varied significantly.

Portion (a) of FIG. 21 illustrates write data. Portion (b) of FIG. 21 illustrates a properly recorded 2T mark. On the other hand, portions (c) and (d) illustrate 2T marks that have been recorded in too big a size and in too small a size, respectively. The write data shown in portion (a) of FIG. 20 has a recording pattern including a 3T space, a 2T mark and a 4T space. In that case, according to the edge detection patterns shown in FIG. 19, 3Ts2Tm should be detected at the leading edge and 2Tm4Ts should be detected at the trailing edge.

In portion (b) of FIG. 21, the 2T mark has been recorded properly, and therefore, the binarized signal to be decoded by the PRML method will have a pattern in which a 3T space, a 2T mark and a 4T space appear in this order. In that case, according to the edge detection patterns shown in FIG. 19, 3Ts2Tm should be detected at the leading edge and 2Tm4Ts should be detected at the trailing edge. Since the recording pattern that was written agrees with the signal pattern thus decoded, the write pulse settings can be adjusted by reference to the edge shift detection patterns described above.

On the other hand, in portion (c) of FIG. 21, the 2T mark was recorded with an expanded leading edge portion, and therefore, the binarized signal to be decoded by the PRML method will have a pattern in which a 2T space, a 3T mark and a 4T space appear in this order. In that case, according to the edge detection patterns shown in FIG. 19, 2Ts3Tm should be detected at the leading edge and 3Tm4Ts should be detected at the trailing edge. Consequently, since the recording pattern that was written disagrees with the signal pattern thus decoded, the write pulse settings will be adjusted on an erroneously detected signal pattern. The same can be said even if a 2T mark was recorded with an expanded trailing edge portion.

And in portion (d) of FIG. 21, the 2T mark was recorded in too small a size, and therefore, the binarized signal to be decoded by the PRML method will have a pattern in which a 4T space, a 2T mark and a 3T space appear in this order. In this example, since the shortest mark length is defined to be 2T, a mark length of 1T cannot be a correct answer. For that reason, even if a recorded mark was formed in too small a size, that recorded mark would also be decoded into a 2T mark as a result of a maximum likelihood decoding process. However, at least one of the spaces that precede and follow that mark could be decoded erroneously as a result. In that case, according to the edge detection patterns shown in FIG. 19, 4Ts2Tm should be detected at the leading edge and 2Tm3Ts should be detected at the trailing edge. Consequently, since the recording pattern that was written disagrees with the signal pattern thus decoded, the write pulse settings will be adjusted on an erroneously detected signal pattern.

As described above, even if write pulse settings are adjusted by the PRML method, the initial write pulse settings should be adjusted in advance (i.e., before short recorded marks are actually adjusted) so that the mark lengths will not be detected erroneously. Likewise, if a read/write operation is performed by the PR 12221 ML method at a storage density of 33.4 GB, a recording pattern including the shortest 2T mark is most likely to cause errors. That is why that preliminary adjustment is preferably carried out before the write pulse settings are determined for the shortest marks. Or the recording pattern to use for making the write adjustment could be a special recording pattern, too.

For example, Patent Document No. 2 discloses a method of adjusting write pulse settings by using the edge shift detection technique of Patent Document No. 1. The method disclosed in Patent Document No. 2 includes the step of adjusting a group of longer marks and then a group of shorter marks. However, according to Patent Document No. 2, the shortest 2T marks and the second shortest 3T marks are adjusted at the same time, and therefore, no preliminary adjustment is supposed to be made before the shortest marks are adjusted. On top of that, no special recording pattern is used, either.

On the other hand, Patent Document No. 3 discloses a method for performing a read/write operation with the writing condition changed so that the Q value becomes zero in a pattern in which the shortest recorded marks and spaces and the second shortest recorded marks and spaces appear. Also, according to Patent Document No. 3, a duty feedback control is adopted to set a reference level for measuring the value.

As described above, at a storage density at which the lengths of the shortest recorded marks and spaces are at the optical diffraction limit, the signal amplitude of the second shortest recorded marks and spaces is also small. That is why even if the β value were detected using the recording pattern disclosed in Patent Document No. 3, the β value could not be measured accurately. On top of that, since the shortest recorded marks and spaces generate a read signal with zero amplitude, the duty of the read signal waveform cannot be detected accurately, either.

Also, each of the methods described above is supposed to be applied to forming recorded marks, of which the lengths are still under the optical diffraction limit. That is why when a high-density write operation needs to be performed by forming recorded marks, of which the lengths are at or beyond the optical diffraction limit, it is difficult to appropriately adjust the write pulse settings by any of the methods described above. That is to say, to adjust the write pulse settings appropriately so that recorded marks that are even shorter than the optical diffraction limit are formed properly, a different method is needed.

Next, the β value will be described. FIG. 22 illustrates how to detect the β value.

As shown in FIG. 22, to obtain the β value, first of all, a reference level Ref is set for the read signal. Next, the peak level A1 and the bottom level A2 of the read signal are detected with respect to the reference level Ref. The β value is calculated by:

β=(A1+A2)/(A1−A2)

The β value is generally used as a signal index indicating the asymmetry of a read signal with respect to the center of the energy of the overall signal.

It is therefore an object of the present invention to provide an apparatus and method for adjusting a writing condition that can be used effectively to adjust write pulse settings appropriately when a high-density write operation needs to be performed by forming recorded marks, of which the lengths are at or beyond the optical diffraction limit, and also provide an apparatus and method for reading and writing information using such an apparatus and method.

### Solution to Problem

A writing condition adjusting apparatus according to the present invention adjusts a writing condition for use to write information on an information recording medium. The apparatus includes a control section for controlling the value of adjustment to be made on the writing condition using first and second recording patterns. The first recording pattern is used to adjust a writing condition for recording marks and spaces, of which the lengths are equal to or longer than a predetermined recording length, while the second recording pattern is used to adjust a writing condition for recording marks and spaces, of which the lengths are shorter than the predetermined recording length by one recording unit length. The control section performs a first write adjustment for adjusting the writing condition for recording marks, of which the lengths are shorter by one recording unit length. The control section decides whether or not the writing condition that has been determined as a result of the first write adjustment needs to be adjusted again. On deciding that the writing condition be adjusted again, the control section sets a signal index value, which has been defined based on the first recording pattern, to be a target value. The control section performs a second write adjustment for adjusting again the writing condition for recording marks, of which the lengths are shorter by one recording unit length, so that a signal index value associated with the one-unit-shorter marks becomes as close to the target value as possible.

In one preferred embodiment, the marks, of which the lengths are shorter by one recording unit length, have lengths that are either at or beyond an optical diffraction limit. On the other hand, the marks, of which the lengths are equal to or longer than the predetermined recording length, have lengths that are still under the optical diffraction limit.

In another preferred embodiment, the marks, of which the lengths are shorter by one recording unit length, have lengths with a spatial frequency of 1.0 or more, and the marks, of which the lengths are equal to or longer than the predetermined recording length, have lengths with a spatial frequency of less than 1.0.

In still another preferred embodiment, the marks and spaces, of which the lengths are shorter by one recording unit length, have such lengths that make the amplitude of a read signal equal to zero in an interval in which there is a series of those marks and spaces that are shorter by one recording unit length.

In yet another preferred embodiment, the signal index value is a β value. In either the first or second recording pattern, a number of combinations of marks and spaces, of which the lengths are equal to or longer than the predetermined recording length, have frequencies of appearance that are equal to each other.

In yet another preferred embodiment, the signal index value is an edge shift detected by maximum likelihood decoding. In a number of combinations of marks and spaces, of which the lengths are equal to or longer than the predetermined recording length, in either the first or second recording pattern, combinations of marks and spaces with the predetermined recording length have the highest frequency of appearance.

In yet another preferred embodiment, in a group of combinations of marks and spaces, of which the lengths are equal to or longer than the predetermined recording length, each of multiple combinations in the first recording pattern has as high a frequency of appearance as its counterpart in the second recording pattern.

In yet another preferred embodiment, in the second recording pattern, a combination of the marks and spaces, of which the lengths are shorter by one recording unit length, has the highest frequency of appearance.

In yet another preferred embodiment, the first recording pattern corresponds to a random signal. The second recording pattern includes, in combination, a random signal corresponding to a combination of marks and spaces, of which the lengths are equal to or longer than the predetermined recording length, and a single signal corresponding to the marks and spaces, of which the lengths are shorter by one recording unit length.

In yet another preferred embodiment, the control section decides, by any of the writing condition that has been determined as a result of the first write adjustment, a β value, a frequency of appearance, and the amount of edge shift with a variation in write pulse settings, whether or not the writing condition needs to be adjusted again.

In yet another preferred embodiment, before making the first write adjustment, the control section performs a third write adjustment for adjusting a writing condition for recording marks with the predetermined recording length using the first recording pattern. The target value is either an edge shift or a β value that is associated with the writing condition that has been determined as a result of the third write adjustment.

In yet another preferred embodiment, the marks, of which the lengths are shorter by one recording unit length, are the shortest marks.

In yet another preferred embodiment, the lengths Tm and Ts of the shortest marks and spaces to be recorded on the information recording medium satisfy (Tm+Ts)<λ/(2×NA), where λ represents the wavelength of a laser beam for use to perform a write operation on the information recording medium and NA represents the numerical aperture of an objective lens.

In a specific preferred embodiment, the laser beam has a wavelength λ of 400 nm to 410 nm.

In a specific preferred embodiment, the objective lens has a numerical aperture NA of 0.84 to 0.86.

In a specific preferred embodiment, the sum Tm+Ts of the length Tm of the shortest marks and the length Ts of the shortest spaces is less than 238.2 nm.

A writing condition adjustment method according to the present invention is a method for adjusting a writing condition for use to write information on an information recording medium. The method includes the steps of: controlling the value of adjustment to be made on the writing condition using first and second recording patterns. The first recording pattern is used to adjust a writing condition for recording marks and spaces, of which the lengths are equal to or longer than a predetermined recording length. On the other hand, the second recording pattern is used to adjust a writing condition for recording marks and spaces, of which the lengths are shorter than the predetermined recording length by one recording unit length. The method further includes the steps of: performing a first write adjustment for adjusting the writing condition for recording marks, of which the lengths are shorter by one recording unit length; deciding whether or not the writing condition that has been determined as a result of the first write adjustment needs to be adjusted again; on deciding that the writing condition be adjusted again, setting a signal index value, which has been defined based on the first recording pattern, to be a target value, and performing a second write adjustment for adjusting again the writing condition for recording marks, of which the lengths are shorter by one recording unit length, so that a signal index value associated with the one-unit-shorter marks becomes as close to the target value as possible.

An information reading and writing apparatus according to the present invention includes: a reading section for generating a digital signal based on an analog signal representing information that has been retrieved from an information recording medium; a write adjustment section for adjusting a writing condition for use to write information on the information recording medium by reference to a signal index value that the write adjustment section has detected by itself from either the analog signal or the digital signal; and a writing section for writing information on the information recording medium under that writing condition. The write adjustment section includes a writing control section for controlling the value of adjustment to be made on the writing condition using first and second recording patterns. The first recording pattern is used to adjust a writing condition for recording marks and spaces, of which the lengths are equal to or longer than a predetermined recording length. The second recording pattern is used to adjust a writing condition for recording marks and spaces, of which the lengths are shorter than the predetermined recording length by one recording unit length. The write adjustment section performs a first write adjustment for adjusting the writing condition for recording marks, of which the lengths are shorter by one recording unit length. The write adjustment section decides whether or not the writing condition that has been determined as a result of the first write adjustment needs to be adjusted again. On deciding that the writing condition be adjusted again, the write adjustment section sets a signal index value, which has been defined based on the first recording pattern, to be a target value. And the write adjustment section performs a second write adjustment for adjusting again the writing condition for recording marks, of which the lengths are shorter by one recording unit length, so that a signal index value associated with the one-unit-shorter marks becomes as close to the target value as possible.

An information reading and writing method according to the present invention includes: a reading step for generating a digital signal based on an analog signal representing information that has been retrieved from an information recording medium; a write adjustment step for adjusting a writing condition for use to write information on the information recording medium by reference to a signal index value that has been detected from either the analog signal or the digital signal; and a writing step for writing information on the information recording medium under that writing condition. The write adjustment step includes the steps of: controlling the value of adjustment to be made on the writing condition using first and second recording patterns, the first recording pattern being used to adjust a writing condition for recording marks and spaces, of which the lengths are equal to or longer than a predetermined recording length, the second recording pattern being used to adjust a writing condition for recording marks and spaces, of which the lengths are shorter than the predetermined recording length by one recording unit length; performing a first write adjustment for adjusting the writing condition for recording marks, of which the lengths are shorter by one recording unit length; deciding whether or not the writing condition that has been determined as a result of the first write adjustment needs to be adjusted again; on deciding that the writing condition be adjusted again, setting a signal index value, which has been defined based on the first recording pattern, to be a target value; and performing a second write adjustment for adjusting again the writing condition for recording marks, of which the lengths are shorter by one recording unit length, so that a signal index value associated with the one-unit-shorter marks becomes as close to the target value as possible.

Another information reading and writing apparatus according to the present invention includes: a reading section for generating a digital signal based on an analog signal representing information that has been retrieved from an information recording medium; a write adjustment section for adjusting a writing condition for use to write information on the information recording medium by reference to a signal index value that the write adjustment section has detected by itself from either the analog signal or the digital signal; and a writing section for writing information on the information recording medium under that writing condition. In adjusting a writing condition for recording marks with a predetermined recording length, the write adjustment section writes, on the information recording medium, a recording pattern that does not include marks, of which the lengths are longer than the predetermined recording length by one recording unit length, and/or marks, of which the lengths are shorter than the predetermined recording length by one recording unit length.

In one preferred embodiment, the predetermined recording length is 2T, and in adjusting a writing condition for recording 2T marks, the write adjustment section writes a recording pattern, which includes no 3T marks, on the information recording medium.

In another preferred embodiment, the recording pattern does not include marks, of which the lengths are longer than the predetermined recording length by two recording unit lengths, either.

In this particular preferred embodiment, the predetermined recording length is 2T, and in adjusting a writing condition for recording 2T marks, the write adjustment section writes a recording pattern, which includes neither 3T marks nor 4T marks, on the information recording medium.

In still another preferred embodiment, the recording pattern includes marks, of which the lengths are longer than the predetermined recording length by two or more recording unit lengths.

In this particular preferred embodiment, the predetermined recording length is 2T, and in adjusting a writing condition for recording 2T marks, the write adjustment section writes a recording pattern, which does include the 2T marks and 4T through 8T marks but which includes no 3T marks, on the information recording medium.

In an alternative preferred embodiment, the predetermined recording length is 3T, and in adjusting a writing condition for recording 3T marks, the write adjustment section writes a recording pattern, which does include the 3T marks and 5T through 8T marks but which includes neither 2T marks nor 4T marks, on the information recording medium.

In yet another preferred embodiment, the write adjustment section further includes a particular edge detecting counter for counting the number of a first kind of edges detected in a read signal representing a mark with the predetermined recording length and/or the number of a second kind of edges detected in a read signal representing a mark that is not included in the recording pattern. The write adjustment section invalidates the signal index value that has been obtained under a writing condition that makes the number of the first kind of edges detected equal to or smaller than a predetermined value and/or a writing condition that makes the number of the second kind of edges detected equal to or greater than the predetermined value.

In this particular preferred embodiment, the predetermined value is determined by the frequency of appearance of the predetermined recording length in the recording pattern.

### Advantageous Effects of Invention

According to the present invention, when write pulse settings need to be adjusted in order to perform a high-density write operation for forming recorded marks, of which the lengths are at or beyond the optical diffraction limit, erroneous detection of the data patterns of the shortest marks, among other things, can be reduced and the write pulse settings can be adjusted appropriately. As a result, a reading/writing system that can operate with good stability by having its error rate reduced while reading or writing information is provided.

### BRIEF DESCRIPTION OF DRAWINGS

FIG. 1 illustrates an information reading and writing apparatus as a preferred embodiment of the present invention.

FIGS. 2(a) and 2(b) show the frequencies of appearance of a first recording pattern according to a preferred embodiment of the present invention.

FIGS. 3(a) and 3(b) show the frequencies of appearance of a second recording pattern according to a preferred embodiment of the present invention.

FIG. 4 illustrates an example of the second recording pattern according to a preferred embodiment of the present invention.

FIG. 5 is a flowchart showing the procedure in which write pulse settings are adjusted in a preferred embodiment of the present invention.

FIG. 6 is a block diagram illustrating a configuration for a DC control section according to a preferred embodiment of the present invention.

FIG. 7 shows an example of the table of writing condition to be made when write pulse settings are adjusted in a preferred embodiment of the present invention.

FIG. 8 shows what read signals will be obtained if a write operation is performed under multiple writing conditions in a preferred embodiment of the present invention.

FIG. 9A is a flowchart illustrating an exemplary series of processing steps to get done to adjust write pulse settings for each and every recorded mark in a preferred embodiment of the present invention.

FIG. 9B is a flowchart showing an exemplary procedure of a method that uses the 2T signal level adjustment as a sort of feedback processing in a preferred embodiment of the present invention.

FIGS. 10(a) and 10(b) show a recording pattern for use in the processing shown in FIG. 9A according to a preferred embodiment of the present invention.

FIGS. 11(a) and 11(b) show the frequencies of appearance of a recording pattern that does not include recorded marks, of which the lengths are different from that of the shortest mark by 1T, according to a preferred embodiment of the present invention.

FIGS. 12(a) and 12(b) show the frequencies of appearance of a fourth recording pattern according to a preferred embodiment of the present invention.

FIGS. 13(a) and 13(b) show the frequencies of appearance of a recording pattern in which recorded marks of the proximate length never appear in a preferred embodiment of the present invention.

FIG. 14 illustrates an information reading and writing apparatus as a specific preferred embodiment of the present invention.

FIG. 15 is a flowchart showing the procedure in which write pulse settings are adjusted in a preferred embodiment of the present invention.

FIGS. 16(a) through 16(c) illustrate a write pulse waveform and its associated recording powers.

FIGS. 17(a) through 17(c) illustrate various write pulse shapes.

FIG. 18 illustrates a reading and writing apparatus.

FIGS. 19(a) and 19(b) are tables of write parameters.

Portions (a) through (c) of FIG. 20 illustrate exemplary waveforms of read signals to be generated when the same write data is stored at mutually different densities.

Portions (a) through (d) of FIG. 21 illustrate a situation where the size of the shortest recorded marks varied significantly.

FIG. 22 illustrates how to detect a β value.

FIG. 23 shows how the signal amplitude changes with the spatial frequency.

FIG. 24 is a table showing expected signal values for use in a maximum likelihood decoding process in a situation where a PR (1, 2, 2, 2, 1) equalization characteristic is adopted.

FIG. 25 shows the respective signal levels of read signals that were subjected to ideal equalization processing in a situation where the PR (1, 2, 2, 2, 1) equalization characteristic is adopted.

### DESCRIPTION OF EMBODIMENTS

Hereinafter, preferred embodiments of the present invention will be described with reference to the accompanying drawings. In the following description, any pair of components shown in multiple drawings and having substantially the same function will be identified by the same reference numeral. And once such a component has been described, the description of its counterpart will be omitted herein to avoid redundancies.

### EMBODIMENT 1

First of all, it Will be Described in What situation the length of a recorded mark is at or beyond the optical diffraction limit in preferred embodiments of the present invention. As used herein, if “the length is at or beyond the optical diffraction limit”, then it means that the length is equal to or shorter than optical diffraction limit.

For example, in a preferred embodiment of the present invention, a 2T mark has a length that is shorter than the optical diffraction limit but a 3T mark has a length that is still under the optical diffraction limit.

Hereinafter, the relation between the OTF (optical transfer function) of DVDs and BDs and the shortest marks and spaces as disclosed in Non-Patent Document No. 1 will be described with reference to FIG. 23, which shows how the signal amplitude changes with the spatial frequency, which is the inverse number of one period of recorded marks. DVDs have a spatial frequency of approximately 0.68 and a signal amplitude of approximately 0.21, while BDs have a spatial frequency of approximately 0.80 and a signal amplitude of approximately 0.10. Also, the spatial frequency, at which the amplitude of the read signal goes zero, is 1.0, which is called “OTF cutoff”.

In this preferred embodiment, a 2T mark may have a length at which the spatial frequency becomes equal to or higher than 1.0, while a 3T mark may have a length at which the spatial frequency becomes less than 1.0, for example. Also, 2T marks and 2T spaces have such lengths at which the read signal has zero amplitude in an interval in which the 2T marks and 2T spaces appear consecutively.

In this case, using the wavelength λ of the laser beam, the numerical aperture NA of the lens, the length Tm of a recorded mark, and the length Ts of a space, the spatial frequency Sp is calculated by the following Equation (1):

Sp=λ/{2×NA×(Tm+Ts)} (1)

As can be seen from this Equation (1), if a DVD uses a laser wavelength of 650 nm, an NA of 0.60 and a shortest mark length of 400 nm, then the spatial frequency will be approximately 0.68. On the other hand, if a BD uses a laser wavelength of 405 nm, an NA of 0.85 and a shortest mark length of 149 nm, then the spatial frequency will be approximately 0.80.

Also, once the optical conditions including the laser wavelength and NA are determined, the lengths Tm and Ts of recorded marks and spaces, which are at or beyond the optical diffraction limit, satisfy the following Equation (2):

(Tm+Ts)<λ/(2×NA) (2)

Supposing DVDs and BDs have the optical conditions mentioned above, the sum of the lengths of the shortest mark and the shortest space (Tm+Ts) becomes approximately 541.7 nm in DVDs and approximately 238.2 nm in BDs. That is why if a recorded mark, of which the length is even shorter than that recorded mark length, were formed, the read signal would have zero amplitude.

In a preferred embodiment of the present invention, recorded marks and spaces, of which the lengths satisfy Equation (2), are formed.

It should be noted that the recorded marks and spaces that have a spatial frequency of 1.0 or more do not always have the shortest length. Rather, according to the storage density, the length of the second shortest recorded marks and spaces may be defined so as to satisfy Equation (2).

In the following description of preferred embodiments, however, only the shortest recorded marks and spaces are supposed to satisfy Equation (2) to avoid redundancies. Also, write pulse adjustments on non-shortest recorded marks are preferably carried out as pre-processing to get ready to make write pulse adjustments on the shortest recorded marks. Furthermore, in this preferred embodiment, the modulation code to use is supposed to be 1-7 PP modulation. In that case, there will be recorded marks and spaces with lengths of 2T through 8T, the shortest length will be 2T, the second shortest length will be 3T, and the longest length will be 8T. The modulation code does not have to be 1-7 PP modulation but the present invention is also applicable to 8-16 modulation, for example.

It should be noted that T represents one channel clock cycle (or channel width). In various preferred embodiments of the present invention, the recording unit length of recorded marks and spaces is T. For example, a 2T mark may be described as a “recorded mark that is shorter by one recording unit length than a 3T mark”. Also, a 4T mark may be described as either “a recorded mark that is longer by two recording unit lengths than a 2T mark” or “a recorded mark that is longer by one recording unit length than a 3T mark”.

Hereinafter, first and second recording patterns for use in this preferred embodiment will be described.

First of all, FIG. 2 shows the frequencies of appearance of the first recording pattern with no shortest marks or spaces. Specifically, FIG. 2(a) shows the frequencies of appearance at the leading edge, while FIG. 2(b) shows the frequencies of appearance at the trailing edge. For example, N3Ts3Tm represents the frequency of appearance of a pattern, of which the preceding space is 3T and the recorded mark is also 3T. In the same way, N3Tm3Ts represents the frequency of appearance of a pattern, of which the recorded mark is 3T and the following space is also 3T. As shown in FIG. 2, the first recording pattern is a recording pattern including no shortest marks or spaces. That is to say, in the recording pattern shown in FIG. 2(a), every edge generated has a combination of a 3T or longer preceding space and a 3T or longer recorded mark. And if the frequencies of appearance are even, then every frequency of appearance should have the same value (i.e., N3Ts3Tm=N4Ts3Tm= . . . =N7Ts8Tm=N8Ts8Tm in FIG. 2(a)). In the example shown in FIG. 2(a), the number of edges with frequencies of appearance is 36, and therefore, each frequency of appearance will be approximately 2.8% (= 1/36). However, as there are a lot of edges with frequencies of appearance, as a DSV control needs to be done, and as the data length of the recording pattern has a limit, it is difficult to make each and every frequency of appearance equal to each other. That is why according to this preferred embodiment, even if the frequencies of appearance are said to be even, not every frequency of appearance has to have the same value. For example, the frequencies of appearance could be varied to the point that the highest frequency of appearance is at most twice as high as the lowest frequency of appearance.

Hereinafter, it will be described how the frequencies of appearance of the first recording pattern will vary in this preferred embodiment if the signal index value is detected as a β value.

In that case, the first recording pattern is supposed to be a recording pattern, of which all frequencies of appearance are even.

Usually, in a random signal to be written as user data, short marks will appear rather frequently. In this example, however, as the β value is treated as a read signal index value, the frequencies of appearance of longer marks are increased, and the number of samples in an envelope signal part of an RF signal is also increased.

Stated otherwise, if the frequencies of appearance of long marks were high, then the β value would also have a value that is biased toward long marks. In that case, if the second shortest recorded marks (i.e., 3T marks) were formed asymmetrically, it would be difficult to make appropriate adjustment on the shortest marks using the second recording pattern to be described later. For that reason, it is preferred that the first recording pattern have even frequency of appearance.

Also, as long as the PLL control and other controls can get done with stability, the first recording pattern could also be a recording pattern in which the second shortest recorded marks and spaces and the longest recorded marks and spaces are weighted (e.g., a recording pattern in which a series of 3T marks and spaces and a series of 8T marks and spaces appear most frequently). Or the first recording pattern may also be a combination of the second shortest recorded marks and spaces and the longest recorded marks and spaces. In that case, a signal including a 3T signal can be used to make adjustments. In addition, the number of samples of β values detected can be increased compared to the situation where the frequencies of appearance are even. For that reason, that would be a more preferred recording pattern.

Optionally, the number of samples can also be increased by extending the duration of read/write monitoring without increasing the frequencies of appearance of long marks. In that case, the recording space to use and the monitoring time to take would both increase. However, a sufficient number of samples can be ensured even for a read signal that has a small number of samples in its envelope signal part.

Furthermore, the first recording pattern is preferably a random signal that has been subjected to a DSV (digital sum value) control. This is because it is preferred that the DC components of a recording pattern signal be eliminated as much as possible by performing the DSV control. The random signal is preferred in order to eliminate variations to be caused by the recording pattern in the envelope signal part.

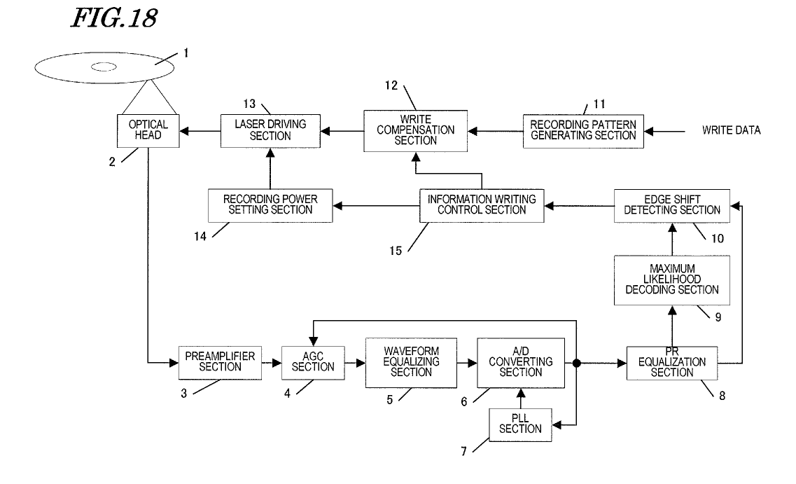

Next, it will be described how high the frequency of appearance of the first recording pattern will be according to this preferred embodiment if the edge shift (see FIG. 18) is detected by maximum likelihood decoding and used as a signal index value.

In that case, as the first recording pattern, a particular pattern (which may be a pattern 3Ts3Tm at the leading edge, for example) can be detected, and the first recording pattern may be weighted so that that particular pattern 3Ts3Tm will be detected more frequently. The weight to add is more preferably determined so that the frequency of appearance will be the highest at the detection edge. Optionally, the frequency of appearance in the random signal to be written as user data can also be used. Furthermore, to set a recording pattern that can also be used even in a situation where the index value is a β value, the first recording pattern may have an even frequency of appearance. Alternatively, the second recording pattern may have an even frequency of appearance.

On top of that, as in a situation where the index value is a β value, the first recording pattern is preferably a random signal that has been subjected to the DSV control. According to maximum likelihood decoding that involves adaptive equalization, if the recording pattern was a special pattern (such as a series of same short signals), the coefficient of the adaptive equalization filter would sometimes fail to converge with stability. For that reason, it is more preferred that a random signal be used as the first recording pattern.

Among write signals, of which the lengths are 3T or more, a 3T signal has the shortest length and highest write sensitivity. That is why if the edge shift is used as a signal index value, it is more preferred that a pattern in which 3T marks and spaces appear consecutively (i.e., 3Ts3Tm or 3Tm3Ts) be detected.

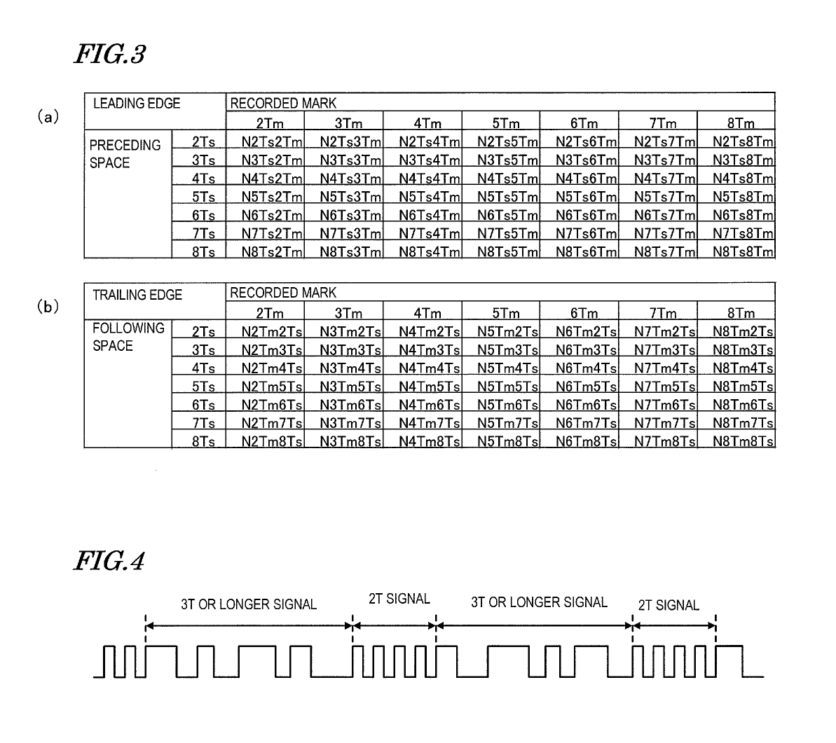

Next, FIG. 3 shows the frequencies of appearance of the second recording pattern including the shortest marks and spaces. Specifically, FIG. 3(a) shows the frequencies of appearance at leading edges, while FIG. 3(b) shows the frequencies of appearance at trailing edges. Unlike the first recording pattern, this second recording pattern does include 2T signals representing the shortest marks and spaces.

A more preferred frequency of appearance of the second recording pattern according to this preferred embodiment will be described.

In the second recording pattern of this preferred embodiment, the sum of the frequencies of appearance of 2T signals (consisting of NXTs2Tm, N2TsXTm, N2TmXTs and NXTm2Ts where X is an integer of two through eight) is equal to or greater than the sum of the frequencies of appearance of the other signals representing 3T or longer marks and spaces (corresponding to the ones shown in FIG. 2). That is to say, the frequencies of appearance are preferably determined so that the sum of the 2T mark and space related signals is longer than that of the 3T or longer mark and space related signals.

Furthermore, the 2T mark and space related signals preferably have uneven frequencies of appearance. And it is more preferred that the frequency of appearance of a signal in which 2T marks and spaces appear consecutively (i.e., only N2Ts2Tm and N2Tm2Ts appear consecutively) be high.

As will be described in detail later, the second recording pattern is used to adjust the write pulse settings of the shortest marks so that the index value detected will be the same as the one to be detected with the first recording pattern. That is why a recording pattern is preferably generated by adding 2T signals to the first recording pattern. Consequently, as for the frequencies of appearance of 3T or longer marks and spaces in the second recording pattern, the frequencies of appearance will be even if the β value is detected as the signal index value but will be obtained by adding weight to the detection edges if the edge shift is detected as the signal index value as in FIG. 2. Or the frequencies of appearance of 3T or longer marks and spaces in the second recording pattern are either exactly or approximately as high as the frequencies of appearance that are set for the first recording pattern. This is preferred in order to prevent the DC components of the write signal from varying depending on whether the recording pattern is the first one or the second one. As described above, in a group of combinations of 3T or longer marks and spaces, each set of combinations in the first recording pattern may have the same frequency of appearance as its associated set in the second recording pattern. Optionally, the second recording pattern may be a pattern in which the combination of 2T marks and spaces has the highest frequency of appearance.

Furthermore, a variation in the thermal interference to be produced due to a difference in length between the preceding or following spaces is preferably minimized. By defining a recording pattern in which 2T signals appear consecutively, the lengths of those preceding and following spaces can be unified into the shortest one, and the variation in the thermal interference produced can be avoided.

Nevertheless, if only 2T signals with no signal amplitude appeared consecutively in great numbers, the PLL would lose its stability of operation. For that reason, the number of 2T signals to appear consecutively is preferably limited to M, which is a positive integer and may be twelve, for example. That number of consecutive 2T signals to be limited may be the maximum number, at or under which the PLL can operate with good stability. Also, if that maximum number is defined by standard, then that number may be naturally adopted as it is.

For these reasons, although it is not practical to generate such a recording pattern in which only 2T signals (i.e., only N2Ts2Tm and N2Tm2Ts) appear consecutively for a long time, it is still preferred that the second recording pattern be obtained by adding weight to as long a train of 2T signals as possible.

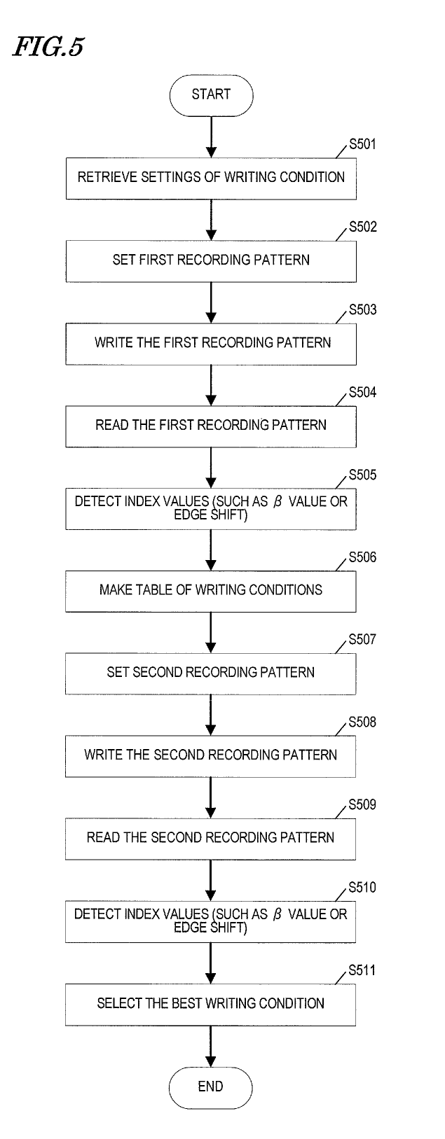

FIG. 4 illustrates an example of the second recording pattern. By inserting a pattern in which the shortest 2T marks and spaces appear consecutively (as a single signal) between random signals consisting of 3T or longer marks and spaces, the second recording pattern is generated. The edge on the boundary between the 2T signal and the random signal consisting of 3T or longer marks and spaces represents the frequency of appearance of a 2T signal (in which not just 2T marks and spaces but other marks and spaces appear), i.e., has one of the patterns NYTs2Tm, N2TsYTm, N2TmYTs and NYTm2Ts, where Y is an integer of three through eight. In this manner, a signal obtained by adding weight to the signal representing a series of 2T marks and spaces and a random signal consisting of 3T or longer marks and spaces can be efficiently combined with each other. It should be noted that this preferred embodiment is not limited to the recording pattern shown in FIG. 4.

The first recording pattern corresponds to the random signal. On the other hand, the second recording pattern is a combination of the random signal including 3T or longer marks and spaces combined and a single signal consisting of 2T marks and spaces.

By performing a read/write operation using both of the first and second recording patterns, the writing condition for the shortest recorded marks can be adjusted.

In the foregoing description, the recording pattern is supposed to have even frequencies of appearance. Actually, however, according to the status of the write signal such as the length of the data to be written, the DSV, and the amount of variation in frequency of appearance due to the introduction of the 2T signal as for the second recording pattern, the recording pattern generated may have frequencies of appearance that are even within a predetermined range (e.g., with an error of ±15% with respect to the average frequency of appearance of the signal consisting of 3T or longer marks and spaces).

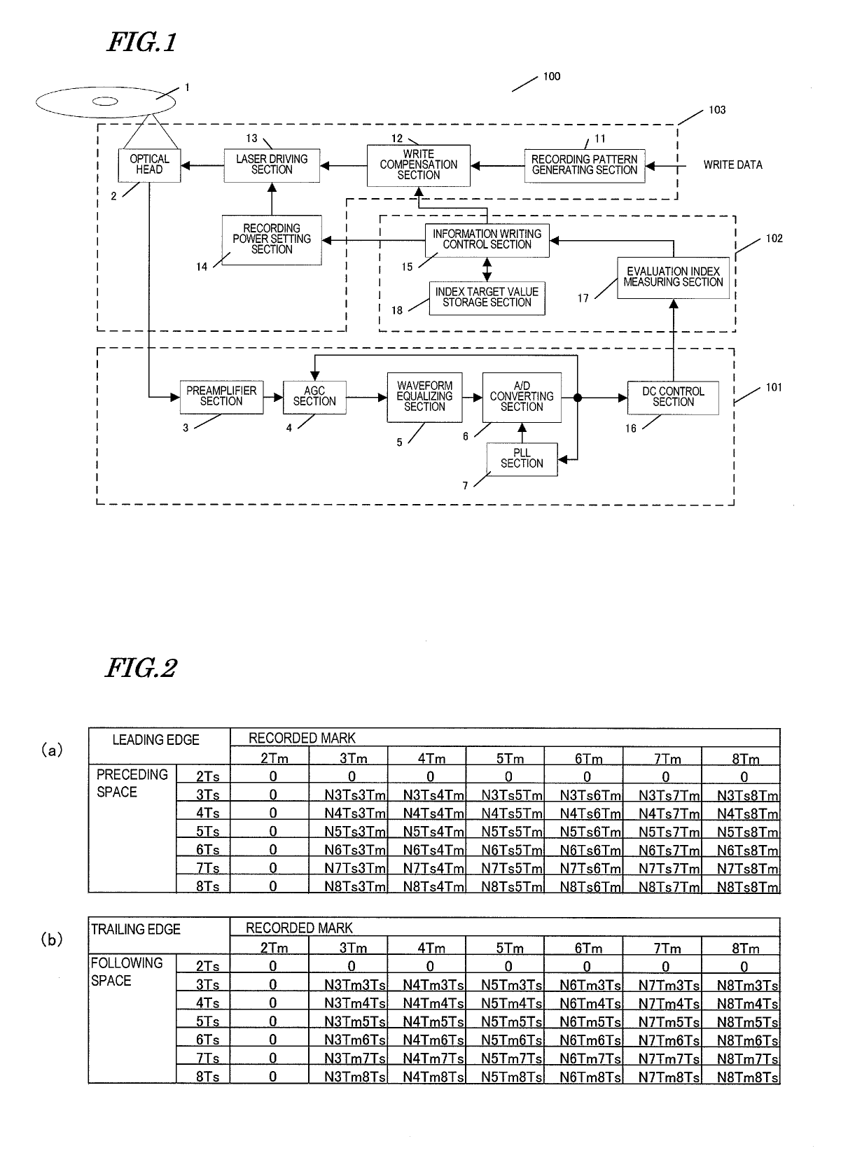

Hereinafter, an information reading and writing apparatus according to the present invention will be described. FIG. 1 illustrates an information reading and writing apparatus 100 as a preferred embodiment of the present invention.

The information reading and writing apparatus 100 includes a reading section 101, a write adjustment section 102, and a writing section 103.

The reading section 101 includes a preamplifier section 3, an AGC section 4, a waveform equalizing section 5, an A/D converting section 6, a PLL section 7 and a DC control section 16.

The write adjustment section 102 includes an information writing control section 15, an index target value storage section 18, and an evaluation index measuring section 17. The write adjustment section 102 detects a signal index value from either an analog signal or a digital signal that has been supplied from the reading section 101 and adjusts the writing condition for writing information on an information recording medium based on the signal index value detected.

The writing section 103 includes an optical head 2, a recording pattern generating section 11, a write compensation section 12, a laser driving section 13 and a recording power setting section 14.

The information reading and writing apparatus 100 is to be loaded with an information recording medium 1, from/on which information can be read or written optically and which may be an optical disc, for example.

The optical head 2 emits a laser beam, converges the laser beam through an objective lens onto a target recording layer of the information recording medium 1, and receives the light reflected from it, thereby generating an analog read signal representing the information that is stored on the information recording medium 1. The objective lens may have a numerical aperture NA of 0.84 to 0.86, which is preferably 0.85, for example. The laser beam may have a wavelength of 400-410 nm, which is preferably 405 nm, for example.

The preamplifier section 3 amplifies the analog read signal with a predetermined gain and outputs the amplified signal to the AGC section 4.

In response, the AGC section 4 amplifies, with a predefined target gain, the read signal provided by the A/D converting section 6 so that the read signal has a constant level and then outputs the amplified signal to the waveform equalizing section 5.

The waveform equalizing section 5 has an LPF characteristic that filters out high frequency components of the read signal and a filter characteristic that amplifies the predetermined frequency range of the read signal, shapes the waveform of the read signal into a desired one, and then outputs it to the A/D converting section 6.

The PLL section 7 generates a read clock signal in response to the waveform equalized read signal and outputs the clock signal to the A/D converting section 6.

The A/D converting section 6 samples the read signal in response to the read clock signal supplied from the PLL section 7, converts the analog read signal into a digital read signal, and then outputs the digital signal to the DC control section 16, the PLL section 7 and the AGC section 4.

The DC control section 16 has the function of removing DC offset, removes the DC offset from the digital read signal provided by the A/D converting section 6, and outputs it to the evaluation index measuring section 17.

The evaluation index measuring section 17 receives the digital read signal from the DC control section 16 and measures the β value and the edge shift, for example. The edge shift is preferably detected by the maximum likelihood decoding method that has already been described with reference to FIG. 18.

To adjust write pulse settings, the information writing control section 15 controls respective circuit sections of this reading and writing apparatus, including the reading section 101, the write adjustment section 102, the writing section 103 and a servo control section (not shown). In addition, the information writing control section 15 also controls choice of the recording pattern and the read/write operation while adjusting the write pulse settings.

If the information writing control section 15 has chosen the first recording pattern that does not include any shortest marks or spaces, then the read/write operation will be performed using an initial set of write pulse settings. In that case, the evaluation index value measured will be stored as an index target value in the index target value storage section 18.

On the other hand, if the information writing control section 15 has chosen the second recording pattern that does include the shortest marks and spaces, the read/write operation will be performed using multiple sets of write pulse settings. In that case, the evaluation index value that has been measured using each set of writing conditions will be compared to the index target value that is stored in the index target value storage section 18, thereby finding which set of write pulse settings has resulted in an evaluation index value closest to the index target value.

Furthermore, the information writing control section 15 controls the writing section 103 so that a write signal including at least one recorded mark, of which the length is at or beyond the optical diffraction limit among the optical conditions for the optical head 2 (such as the wavelength of the laser beam and NA), will be written on the information recording medium. For example, based on preferred conditions for the optical head 2, combined length of the shortest mark and the shortest space is set to be less than 238.2 nm.

Also, in controlling the evaluation index measuring section 17 so that an edge shift is detected by maximum likelihood decoding, the information writing control section 15 determines the best equalization method (e.g., PR (1, 2, 2, 2, 1) equalization) by the recorded mark length that has been set for the evaluation index measuring section 17.

The information writing control section 15 may be an optical disc controller, for example.

The index target value storage section 18 stores the index value that has been specified by the information writing control section 15. It is preferred that the index target value to be stored in the index target value storage section 18 be set every time the write pulse settings are adjusted. For that reason, the index target value storage section 18 is preferably a programmable memory.

The recording pattern generating section 11 generates an NRZI signal to be a recording pattern based on the input write data. The write compensation section 12 generates a write pulse train based on the NRZI signal using the write parameters to be changed by the information writing control section 15. The recording power setting section 14 sets respective recording powers such as a peak power Pp and a bottom power Pb. The laser driving section 13 controls the laser emission operation by the optical head 2 using the write pulse train and the recording power that has been set by the recording power setting section 14.

Hereinafter, it will be described in further detail exactly how the information reading and writing apparatus 100 adjusts the write pulse settings. In the following example, among various write parameters (or write pulse settings) of the shortest 2T marks, only its pulse width Ttop (which will be identified herein by “Ttop2T”) is supposed to be adjusted. Also, in the example to be described below, the write operation is supposed to be performed without changing any other write pulse settings (including the write pulse settings of 3T or longer recorded marks) but the pulse width Ttop2T, and the description of those other situations will be omitted herein.

FIG. 5 is a flowchart showing the procedure in which the reading and writing apparatus 100 of this preferred embodiment adjusts the write pulse settings. In the following description of preferred embodiments of the present invention, the adjustment processing shown in FIG. 5 will be referred to herein as “signal level adjustment”.

Hereinafter, the procedure of adjusting the write pulse settings will be described with reference to FIG. 5. This write pulse adjustment is carried out by the information reading and writing apparatus 100 on the information recording medium 1.

In the first step S501, a writing condition is retrieved.

Specifically, the information reading and writing apparatus 100 retrieves information about the recording power and write pulse settings, which is stored inside either the information recording medium 1 or the apparatus 100 itself (e.g., in its internal memory), as write parameters representing a set of initial writing conditions.

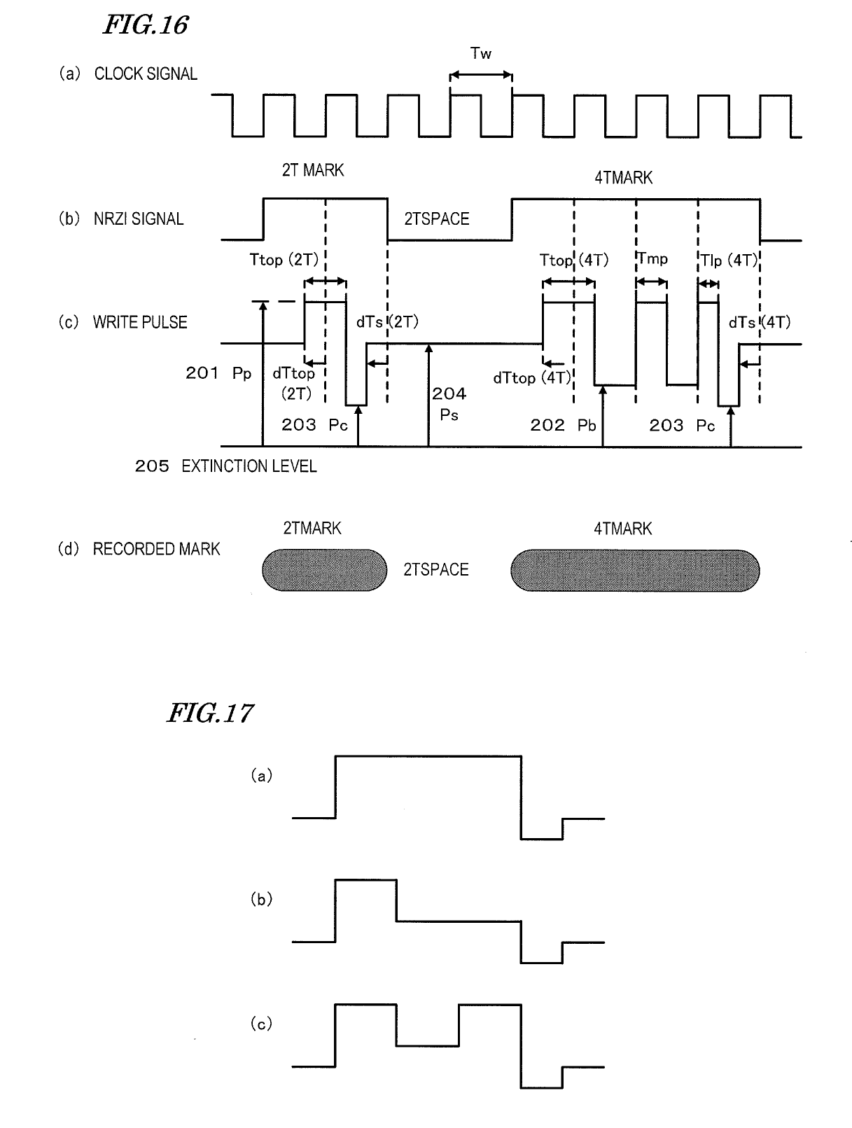

In this case, the information stored inside the information recording medium 1 refers to values representing writing conditions that were specified by the manufacturer of the recording medium during its manufacturing process based on a result of evaluation of the recording property of the information recording medium. Examples of such information stored inside the information recording medium 1 include writing conditions that were written by the apparatus itself in an area of the information recording medium 1, which is provided to store the reading and writing apparatus' (e.g., optical disc drive's) own information. On the other hand, examples of such information stored inside the information reading and writing apparatus 100 include values representing writing conditions that were specified by the manufacturer of the apparatus during its manufacturing process based on a result of evaluation of the write performance of the apparatus. Also, if history information of the writing conditions that the reading and writing apparatus itself has once used on the information recording medium is stored, then that history information is also included. It should be noted that the recording power and the write pulse settings are settings of the recording power and the write pulses that have already been described with reference to FIGS. 16 and 17.

Next, in the second step S502, the first recording pattern including no shortest marks or spaces is set.

In this processing step, the information writing control section 15 instructs the recording pattern generating section 11 what recording pattern should be used. The first recording pattern may be generated every time a write operation is performed. But to save the time for generating a recording pattern, it is preferred that recording patterns that have been generated in advance be stored inside the information reading and writing apparatus.

The recording pattern generating section 11 generates an NRZI signal based on the recording pattern specified.

Based on the write pulse waveform that has been supplied as a write parameter from the information writing control section 15 and the NRZI signal supplied from the recording pattern generating section 11, the write compensation section 12 generates a write pulse train representing a laser emission waveform.

The recording power setting section 14 sets respective recording powers such as the peak power Pp and the bottom power Pb based on the initial writing conditions provided by the information writing control section 15.

In the third step S503, a write operation is performed to write the first recording pattern on the information recording medium 1.

The information writing control section 15 moves the optical head 2 to a recording area provided for adjusting write parameters. That recording area may be defined as the innermost area of an information recording medium for the purpose of adjusting the recording power and the write pulses. In DVDs, such an area is called a PCA (power calibration area). Also, if the manufacturer needs to evaluate the recording property of an information recording medium or the write performance of a reading and writing apparatus during their manufacturing process, the user data area to write user data on could also be used for that purpose.

Next, using the write pulse train that has been generated by the write compensation section 12 and the recording power that has been set by the recording power setting section 14, the laser driving section 13 controls the laser emission operation by the optical head 2, thereby writing the first recording pattern at a predetermined recording length (which may be the minimum recording unit length on an address basis, for example) on tracks (not shown) in the recording area of the information recording medium 1.

In this case, if the information recording medium 1 is a rewritable optical disc, the information reading and writing apparatus 100 performs an overwrite operation n times (where n is a positive integer and n==10, for example) on the same recording area while writing the recording pattern. On the other hand, if the information recording medium 1 is a write-once optical disc, then no overwrite can be done on that type of disc, and therefore, a write operation can be performed on it only once.

In the fourth step S504, the operation of reading the first recording pattern written is performed.

For that purpose, the information reading and writing apparatus 100 scans the tracks on which the first recording pattern has been written.

The optical head 2 generates an analog read signal representing the information that has been retrieved from the information recording medium 1. The analog read signal is amplified and AC coupled by the preamplifier section 3 and then passed to the AGC section 4, which controls the gain so that the output of the waveform equalizing section 5 that follows the AGC section 4 will have constant amplitude. After having been output from the AGC section 4, the analog read signal has its waveform shaped by the waveform equalizing section 5 and then is supplied to the A/D converting section 6. In response to a read clock signal supplied from the PLL section 7, the A/D converting section 6 samples the analog read signal. And the PLL section 7 extracts read clock pulses from the digital read signal that has been sampled by the A/D converting section 6.

The digital read signal that has been generated as a result of sampling done by the A/D converting section 6 is input to the DC control section 16.

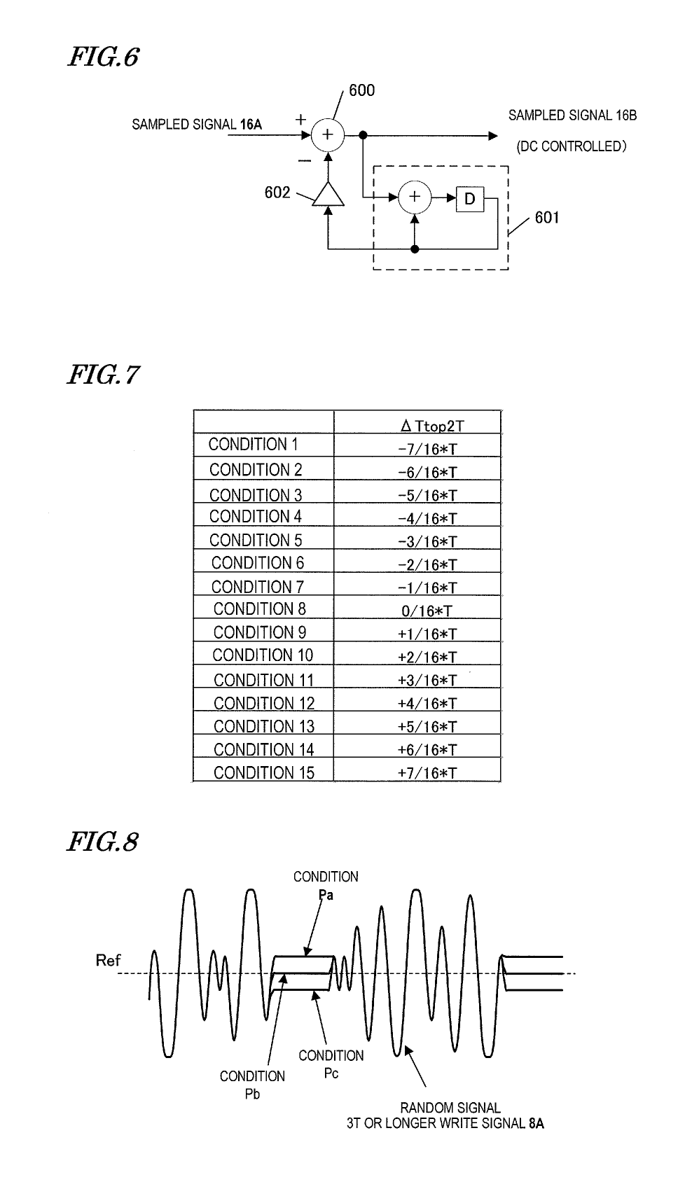

Now the DC control section 16 will be described. FIG. 6 is a block diagram illustrating a configuration for the DC control section 16, which includes an adder 600, an integrator 601 (made up of an adder and a delay circuit), and a gain circuit 602. The adder 600 subtracts the energy center level detected from the incoming sampled signal 16A, thereby removing DC offset components so that the energy center has zero level. The integrator 601 calculates the integral of the sampled signals that have been subjected to the DC control, thereby detecting the energy center level. The gain circuit 602 determines the response with which the energy center level that has been detected by the integrator 601 is fed back as a DC control level to the adder 600. Since the data read signal's own frequency component should not be affected, normally the response is preferably less than a one-thousandth.

In this manner, since the center level of the entire energy is detected, DC offset components can also be removed even from a read signal with no signal amplitude. A digital read signal, from which the DC offset components have been removed (i.e., a DC-controlled sampled signal 16B) is input to the evaluation index measuring section 17.

In the fifth step S505, either a β value or an edge shift is detected as the index value.

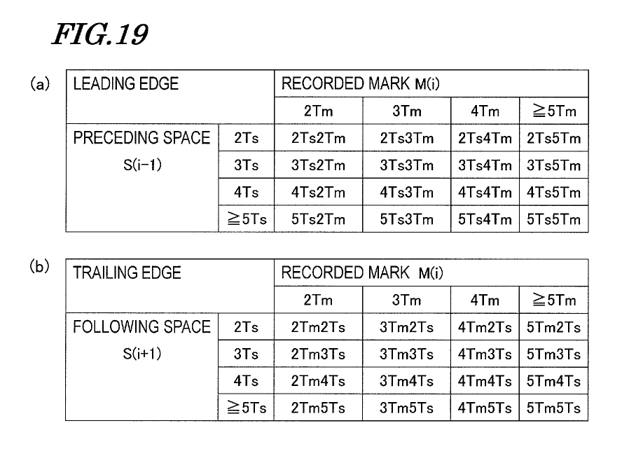

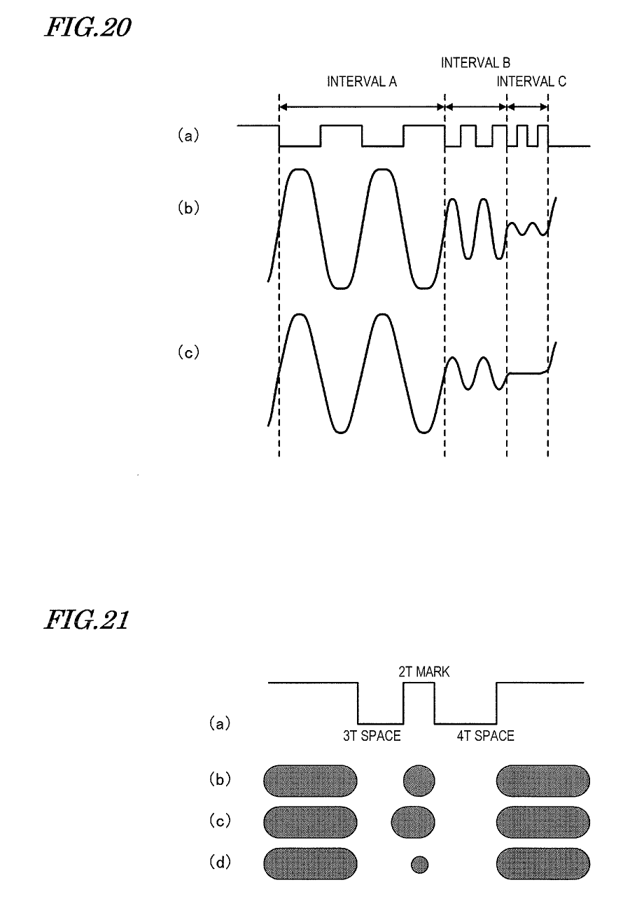

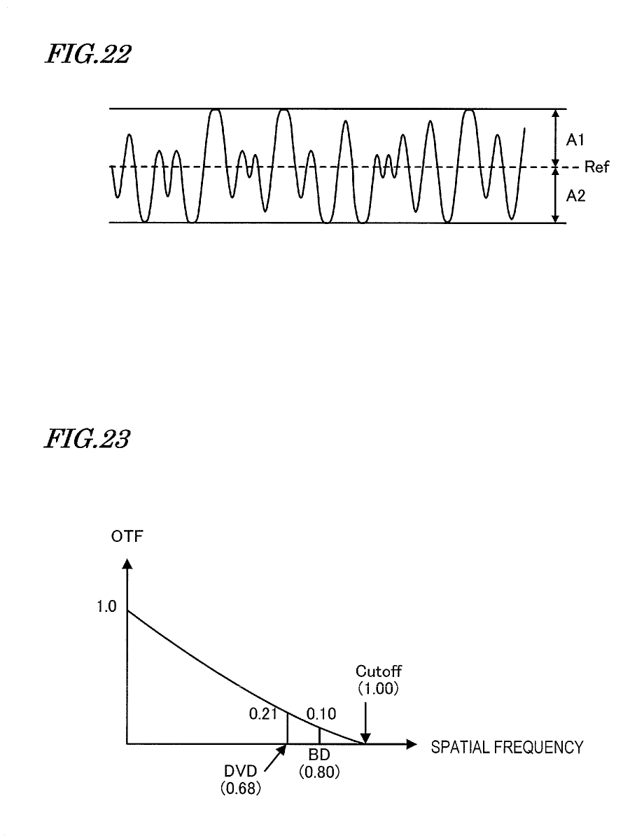

The evaluation index measuring section 17 detects either a β value or an edge shift from the digital read signal supplied from the DC control section 16. As the edge shift, a particular one of the patterns shown in FIG. 19 (e.g., the pattern 3Ts3Tm at the leading edge) may be detected.

The β value or edge shift that has been detected by the evaluation index measuring section 17 is stored in the index target value storage section 18. In this case, the R value or edge shift does not always have to be zero but will be a target value in the processing steps that follow.

In the sixth step S506, a table of writing conditions is made.

Specifically, the information writing control section 15 makes a table of writing conditions for use to write a predetermined recording pattern under multiple writing conditions.

FIG. 7 shows an example of the table of writing conditions to be made in the processing step S506. In FIG. 7, ΔTtop2T represents the offset value with respect to the initial pulse width setting Ttop2T and T represents one write clock cycle. In the exemplary table of writing conditions shown in FIG. 7, the offset value is represented in the unit obtained by dividing one write clock cycle by 16, and 15 different Writing Conditions #1 through #15 are defined. Specifically, Writing Condition #8 is the same as the initial write pulse setting. Since Writing Condition #1 is a setting for decreasing the pulse width Ttop2T, the recorded mark to be formed will shrink. On the other hand, since Writing Condition #15 is a setting for increasing the pulse width Ttop2T, the recorded mark to be formed will expand. Although the pulse width Ttop is supposed to be varied in this example to change the size of the shortest mark, any other parameter (such as dTtop and/or dTs) could also be varied at the same time. Also, to change the size of the recorded mark, the recording power Pp could be varied for only the shortest mark

In the seventh step S507, a second recording pattern, including the shortest marks and spaces, is set.

In this processing step, the information writing control section 15 instructs the recording pattern generating section 11 what recording pattern should be used. The second recording pattern may be generated every time a write operation is performed. But to save the time for generating a recording pattern, it is preferred that recording patterns that have been generated in advance be stored inside the information reading and writing apparatus.

The recording pattern generating section 11 generates an NRZI signal based on the recording pattern specified.

Based on the write pulse waveform that has been supplied as a write parameter from the information writing control section 15 and the NRZI signal supplied from the recording pattern generating section 11, the write compensation section 12 generates a write pulse train representing a laser emission waveform.

The recording power setting section 14 sets respective recording powers such as the peak power Pp and the bottom power Pb based on the initial writing conditions provided by the information writing control section 15.

In the eighth step S508, the operation of writing the second recording pattern on the information recording medium 1 is performed.

The information writing control section 15 controls the write operation so that the second recording pattern is written on a different track from the one that was used in the processing step S503. This must be done particularly if the given information recording medium is a write-once optical disc because no overwrite is permitted in that case. However, if the given information recording medium is a rewritable optical disc and if that recording medium should work fine even if overwrite were done on it, then overwrite may be permitted in some cases.

Next, using the write pulse train that has been generated by the write compensation section 12 and the recording power that has been set by the recording power setting section 14, the laser driving section 13 controls the laser emission operation by the optical head 2, thereby writing the second recording pattern at a predetermined recording length (which may be the minimum recording unit length on an address basis, for example) on tracks in the recording area of the information recording medium 1. In this processing step, the information writing control section 15 controls the write operation so that the laser driving section writes the second recording pattern with the writing conditions changed by reference to the table of writing conditions that has been made in the processing step S506.

As in the processing step S503 described above, if the information recording medium 1 is a rewritable optical disc, the information reading and writing apparatus 100 performs an overwrite operation n times (where n is a positive integer and n=10, for example) on the same recording area while writing the recording pattern.

In the ninth step S509, the operation of reading the second recording pattern that has been written under multiple writing conditions is performed.

Specifically, for that purpose, the information reading and writing apparatus 100 scans the tracks on which the second recording pattern has been written under multiple writing conditions.

Next, the read signals that have been obtained under the respective writing conditions are processed as in the processing step S504. And the digital read signals, which have been generated by the A/D converting section 6 under those multiple writing conditions, have their DC offset components removed by the DC control section 16 and then are passed to the evaluation index measuring section 17.

In the tenth step S510, β values or edge shifts that are associated with the multiple writing conditions are detected as index values.

In this processing step, the evaluation index measuring section 17 detects either values or edge shifts that are associated with the respective writing conditions from the digital read signal that has been provided by the A/D converting section 16.

And in the eleventh step S511, the best writing condition is selected.

For that purpose, the information writing control section 15 compares the 3 values or edge shifts that are associated with the multiple writing conditions and that have just been detected in the previous processing step S510 to the 3 value or edge shift that has been stored as the index target value in the index target value storage section 18 in the processing step S505. And the control section 15 finds which of those index values (which are either 3 values or edge shifts) detected in the processing step S510 is closest to the index target value, and chooses the writing condition that is associated with that closest index value.

FIG. 8 shows what read signals will be obtained if the read/write operation is performed under multiple writing conditions in those processing steps S508 to S510.

In FIG. 8, Condition Pa represents a read signal to be obtained when the shortest mark has been formed in a smaller size than what it should be. Condition Pb represents a read signal to be obtained when the shortest mark has been formed just in its appropriate size. And Condition Pc represents a read signal to be obtained when the shortest mark has been formed in a bigger size than expected. In this case, since the lengths of those recorded marks are beyond the optical diffraction limit, a part of each of those read signals where the shortest marks and spaces appear consecutively becomes a DC-level read signal with no signal amplitude at all, no matter which of those writing conditions is adopted. As for a random signal 8A as a write signal representing 3T or longer marks and spaces, the write pulse settings for no recorded marks but the shortest ones are changed, and therefore, the signal level of the read signal does not change.

The dotted Ref signal level is defined by detecting the index target value in Step S505 after the first recording pattern has been read or written. In this preferred embodiment, the Ref signal level is supposed to be the energy center level. However, if edge shifts need to be detected, the Ref signal level may also be a slice level.

In this case, if the energy center level of the second recording pattern including the shortest marks and spaces is as high as that of the first recording pattern (i.e., if Condition Pb is adopted), then the index value to be detected in the second recording pattern becomes substantially the same as the index target value. In this manner, the size of the shortest marks can be adjusted relatively with respect to those of the other non-shortest recorded marks. And by selecting one of the multiple index values to be detected in the second recording pattern, which is closest to the index target value, and by adopting a writing condition associated with that closest index value, an appropriate writing condition can be determined for the shortest mark.

As described above, according to this preferred embodiment, the size of a recorded mark is changed by adjusting either the write pulse width or the recording power of the shortest mark, thereby controlling the signal level (or DC components) of the recorded mark and adjusting the initial write pulse setting to such a range in which the length of the shortest mark is never taken for that of any other longer recorded mark.

Next, it will be described how to get the write pulse adjustment processing done by making the signal level adjustment as described above.

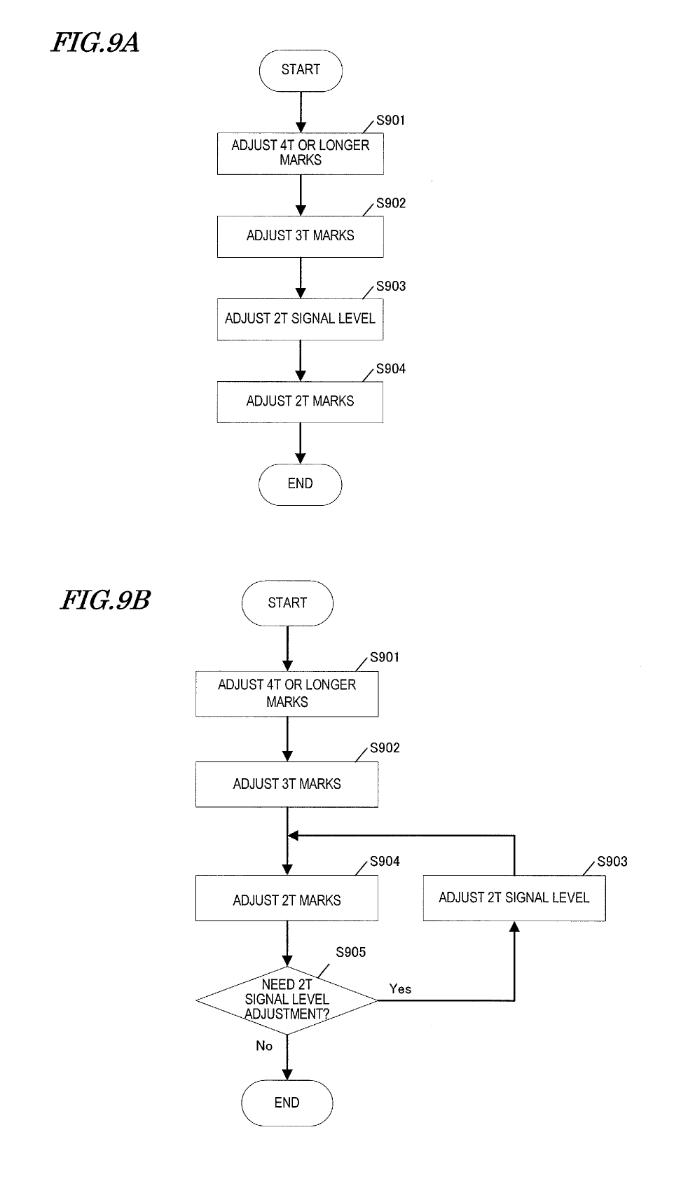

FIG. 9A is a flowchart illustrating a series of processing steps to get done to adjust write pulse settings for each and every recorded mark. As for exactly how to adjust the write pulse settings and how to detect edge shifts, those processing methods are already disclosed in detail in Patent Documents Nos. 1 and 2 (the entire disclosure of which are hereby incorporated by reference), and a detailed description thereof will be omitted herein. In the following description, just the specific recording pattern for use to make the write pulse adjustment and the processing step of carrying out the respective adjustments one item after another will be described.

The information writing control section 15 controls the writing condition adjustment processing that uses the first and second recording patterns. For that purpose, the information writing control section 15 controls the operation of the information reading and writing apparatus, and not only the process shown in FIG. 9A but also the one shown in FIG. 9B to be described later are controlled by the information writing control section 15.

In the first step S901 shown in FIG. 9A, long marks are adjusted.

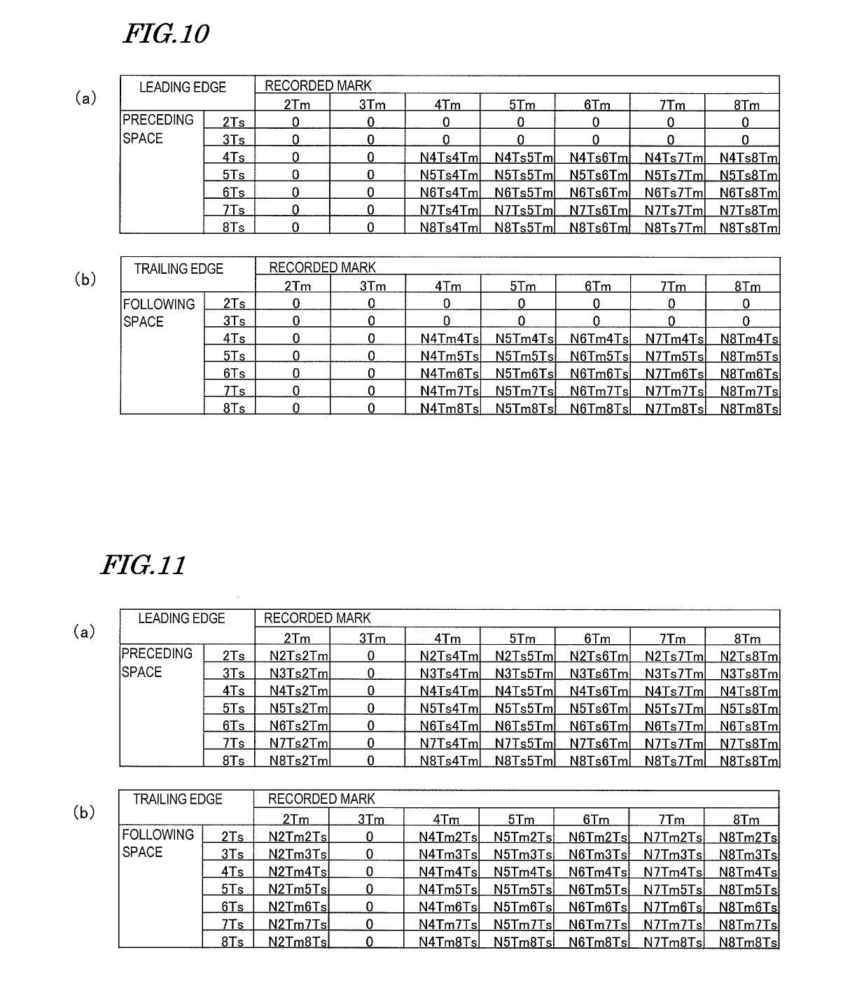

The frequencies of appearance of the recording patterns for use in this processing step S901 are shown in FIG. 10. Specifically, FIG. 10(a) shows their frequencies of appearance at the leading edge, while FIG. 10(b) shows their frequencies of appearance at the trailing edge. The recording patterns to be generated with the frequencies of appearance shown in FIG. 10 are those of a random signal in which 4T through 8T signals appear. And each of those signals preferably appears as frequently as any other one of them. It should be noted that the write pulse settings of long marks are defined by the same kind of parameters such as Ttop of Tmp. For that reason, the frequencies of appearance of the recording patterns shown in FIG. 10 do not always have to be even but those recording patterns could also form a single signal with a particular pattern.

The information reading and writing apparatus reads or writes recording patterns, which are generated with the frequencies of appearance shown in FIG. 10, from/on an information recording medium using multiple write pulse settings for long marks. Next, the apparatus measures one of various kinds of index values including value, asymmetry and edge shift with respect to the read signals associated with those write pulse settings. Furthermore, the information reading and writing apparatus determines a write pulse setting that will result in the same value as the index target value that is stored inside either the information recording medium or the apparatus itself.

In this manner, write pulse settings are adjusted for long marks.

Next, in the second step S902, 3T marks are adjusted.

The recording patterns for use in this processing step S902 are the same as the first recording pattern described above. In the first recording pattern, however, edges about 3T marks and 3T spaces are added, which is a difference from the recording patterns shown in FIG. 10.

The information reading and writing apparatus writes the first recording pattern on the information recording medium using multiple write pulse settings for 3T marks and reads the pattern written. Next, the apparatus measures the edge shifts for the read signals associated with those multiple write pulse settings. And then the information reading and writing apparatus determines a write pulse setting that will result in the same value as the target edge shift value that is stored either inside the information recording medium or inside the apparatus itself.

In this manner, write pulse settings are adjusted for the 3T marks. However, in the first recording pattern, the write pulse settings have not been adjusted yet as for 3T-space-involving long marks (i.e., 4T or longer marks that form an edge in combination with a 3T space). That is why if those 3T-space-involving long marks have not been formed successfully even when the result of the long mark adjustment made in Step S901 is applied, then write pulse settings for those 3T-space-involving long marks are preferably adjusted in this processing step S902, in which the 3T-space-involving long marks are adjusted at the same time with, just before, or right after the 3T marks.

Next, in the third step S903, the level of 2T signals is adjusted.

As already described with reference to FIGS. 5 and 8, when the level of 2T signals is adjusted, write pulse settings are adjusted by controlling the signal level (or DC components) of the recorded marks. Thus, a detailed description of this processing step S903 will be omitted herein.

As described above, by the time when the processing step S902 is performed, write pulse settings have already been adjusted appropriately for every mark but the shortest one. If the settings should be changed significantly with respect to the initial ones while the write pulse settings are adjusted before that processing step S902, then the write pulse settings for 3T or longer marks would become significantly from the unadjusted ones for the shortest mark. Or in some cases, the initial settings for the shortest mark themselves could be quite different from the ones for the other marks from the beginning. In that case, by performing this processing step S903, adjustments can be done between the shortest mark and 3T or longer marks. By making such an adjustment in advance, when 2T marks are adjusted in the next processing step S904, the 2T involving edge shift pattern will never be detected erroneously and the write pulse settings can be adjusted accurately.

Next, in the fourth processing step S904, 2T marks are adjusted.

The recording patterns for use in this processing step S904 are the same as the second recording pattern described above. In the second recording pattern, however, edges about 2T marks and 2T spaces are added, which is a difference from the first recording pattern.

The information reading and writing apparatus writes the second recording pattern on the information recording medium using multiple write pulse settings for 2T marks and reads the pattern written. Next, the apparatus measures the edge shifts for the read signals associated with those multiple write pulse settings. And then the information reading and writing apparatus determines a write pulse setting that will result in the same value as the target edge shift value that is stored either inside the information recording medium or inside the apparatus itself.

In this manner, write pulse settings are adjusted for the 2T marks. However, in the second recording pattern, the write pulse settings have not been adjusted yet as for 2T-space-involving 3T or longer recorded marks (i.e., 3T or longer recorded marks that form an edge in combination with a 2T space). That is why if those 2T-space-involving 3T or longer recorded marks have not been formed successfully even when the result of the adjustment made in Step S901 or S902 is applied, then write pulse settings for those 2T-space-involving 3T or longer recorded marks are preferably adjusted in this processing step S904, in which the 2T-space-involving 3T or longer recorded marks are adjusted at the same time with, just before, or right after the 2T marks.

Next, an adjustment method that uses the 2T signal level adjustment as a sort of feedback processing will be described. FIG. 9B is a flowchart showing the procedure of such a method that uses the 2T signal level adjustment as a sort of feedback processing. In FIG. 9B, the same processing step as its counterpart shown in FIG. 9A is identified by the same reference numeral, and the description thereof will be omitted herein. In the processing shown in FIG. 9B, the information writing control section 15 carries out write adjustment for adjusting a writing condition for recording 2T marks and then decides whether or not the writing condition once determined needs to be adjusted again. If the answer is YES, the apparatus 15 sets the signal index value that has been determined based on the first recording pattern to be a target value and adjusts the writing condition for recording 2T marks again so that the signal index value associated with 2T marks becomes as close to the target value as possible.

As shown in FIG. 9B, long marks are adjusted in the first processing step S901, 3T marks and 2T marks are adjusted in the second and third processing steps S902 and S904, respectively, and then it is determined, in the fourth processing step S905, whether or not the 2T signal level adjustment needs to be done.

That processing step S905 of deciding whether or not the 2T signal level adjustment needs to be done will be described in detail. To make this decision, it is determined whether or not the writing condition that has been once adjusted in the previous processing step S904 should be adjusted all over again. And that decision is made by one of the following methods:

For example, that decision may be made based on the writing condition that has been determined as a result of the 2T mark adjustment. In that case, in the processing step S905, the information reading and writing apparatus confirms the writing condition that has been determined in the previous 2T mark adjustment processing step S904.

In the 2T mark adjustment processing step S904, edge shifts are measured, thereby selecting a write pulse setting that will result in the same value as the target value of the 2T mark adjustment. In this case, the information reading and writing apparatus changes the write pulse setting within a predetermined range that has been set in advance (e.g., within a range of ±5 steps, where one step is one-sixteenth of the width of a write clock pulse), thereby adjusting the 2T mark.

That is why if any write pulse setting that will produce the same edge shift as the target one has been selected from within that predetermined range, then the information reading and writing apparatus has decided that no 2T signal level adjustment be made because the 2T mark has been adjusted appropriately.

On the other hand, if no write pulse setting that will produce the same edge shift as the target one has been selected from within that predetermined range, then the information reading and writing apparatus has decided that the 2T signal level adjustment be made because the 2T mark has not been adjusted appropriately.

And if it has been decided in Step S905 that the 2T signal level adjustment be made, then the fifth processing step S903 is carried out.

However, if it has been decided that no 2T signal level adjustment be made, then the write pulse adjustment ends without performing the fifth processing step S905. In that case, since the 2T signal level adjustment is not carried out, the write adjustment can be done in a shorter time. In addition, if the given recording medium is a write-once optical disc, the recording space to use can be cut down, too.

Alternatively, according to another method, it can also be decided based on a β value whether or not the 2T signal level adjustment needs to be made. In that case, in the processing step S905, the information reading and writing apparatus confirms a β value associated with the write pulse setting that has been determined in the previous 2T mark adjustment processing step S904.

Then, using the write pulse setting that has been determined as a result of the 2T mark adjustment, the information reading and writing apparatus reads or writes either the second recording pattern or a random signal representing user data, thereby detecting a β value.

If the β value detected falls within a predetermined range (e.g., when −10%≦β≦15%), then the information reading and writing apparatus decides that no 2T signal level adjustment be made because the 2T mark has been recorded to have a length falling within the expected range.

On the other hand, if the β value detected falls out of the predetermined range (e.g., when β<−10% or β>15%), then the information reading and writing apparatus decides that the 2T signal level adjustment be made because the 2T mark has not been recorded to have a length falling within the expected range.

And if has been decided in Step S905 that the 2T signal level adjustment be made, the fifth processing step S903 is carried out. Otherwise, the write pulse adjustment ends.

The β value for use in the processing step S905 is more preferably what has been measured while the edge shift is detected in the previous 2T mark adjustment processing step S904. In that case, the β value to retain should be at least associated with the write pulse setting that has been finally selected as a result of the 2T mark adjustment.

Then there is no need to perform the processing of detecting the β value in the processing step S905, and the read/write operation that should otherwise be done in the processing step S905 can be omitted. As a result, the time it takes to get the write adjustment done and the recording space to use (in the case of a write-once optical disc) can be both saved.

Still alternatively, it can also be decided by the frequency of appearance of a recording pattern whether or not the 2T signal level adjustment needs to be done. In that case, in the processing step S905, the information reading and writing apparatus confirms the frequency of appearance of the recording pattern associated with the write pulse setting that has been determined in the 2T mark adjustment processing step S904.

The information reading and writing apparatus writes a recording pattern (e.g., the second recording pattern), of which the frequency of appearance has been known in advance, using the write pulse setting that has been determined as a result of the 2T mark adjustment, reads the pattern written, and then detects its frequency of appearance with respect to marks of a particular length (which are preferably 2T marks that have just been subjected to the write adjustment).

If the ratio of the frequency of appearance of those marks of a particular length detected to that of the recording pattern exceeds a predetermined value (e.g., 90%), then the information reading and writing apparatus has decided that the 2T marks have been recorded so as to have lengths falling within the predetermined range, and therefore, there is no need to make the 2T signal level adjustment.

On the other hand, if the ratio of the frequency of appearance of those marks of a particular length detected to that of the recording pattern is less than the predetermined value, then the information reading and writing apparatus has decided that not every 2T mark has been recorded so as to have its length falling within the predetermined range, and therefore, the 2T signal level adjustment should be made.

And if has been decided in Step S905 that the 2T signal level adjustment be made, the fifth processing step S903 is carried out. Otherwise, the write pulse adjustment ends.

It should be noted that the frequency of appearance for use in the processing step S905 is more preferably what has been detected while the edge shift is detected in the previous 2T mark adjustment processing step S904. In that case, the frequency of appearance to retain should be at least associated with the write pulse setting that has been finally selected as a result of the 2T mark adjustment.

Then there is no need to perform the read/write operation for detecting the frequency of appearance in the processing step S905. As a result, the time it takes to get the write adjustment done and the recording space to use (in the case of a write-once optical disc) can be both saved.

Optionally, the frequency of appearance of spaces of a particular length may be detected instead of that of such marks of the particular length.

In that case, if the mark that has just been subjected to the write adjustment is a 2T mark, that particular space length is preferably at least equal to “2T+shortest space length+shortest space length” (i.e., a 6T space). This is because if 2T marks have been recorded in too small a size to be detected in the read signal, a long space length, including a 2T mark and its preceding and following spaces, will be detected.

It should be noted that if it has been discovered, while the frequency of appearance of those marks is being detected, that the ratio of their frequency of appearance to that of the recording pattern exceeds a predetermined value (e.g., 110%), then it is decided that not every 2T mark has been recorded to have a length falling within the predetermined range. In that case, it is decided that the 2T signal level adjustment be made.

Still alternatively, it may also be determined, by sensing how much the edge shift has varied according to the write pulse setting, whether the 2T signal level adjustment should be made or not. In that case, in the processing step S905, the information reading and writing apparatus sees how much the edge shift has varied with the write pulse setting that has been selected in the 2T mark adjustment processing step S904.

For that purpose, the information reading and writing apparatus writes either the second recording pattern or a random signal representing the user data using multiple write pulse settings, including at least what has been selected as a result of the 2T mark adjustment, reads that pattern or signal written, and then sees how much the edge shift has varied with each of those write pulse settings.

If the variations in edge shift to be detected with the multiple write pulse settings changed are equal to or greater than a prescribed value, then the information reading and writing apparatus decides that no 2T signal level adjustment be made because the 2T marks have been recorded to have lengths falling within the predetermined range.

On the other hand, if the variations in edge shift to be detected with the multiple write pulse settings changed are less than the prescribed amount of variation, then the information reading and writing apparatus decides that the 2T signal level adjustment be made because not every 2T mark has been recorded to have a length falling within the predetermined range.

In this case, the prescribed amount of variation is calculated based on variations in those multiple write pulse settings. For example, if one step is a unit obtained by dividing the pulse width of one write clock pulse by 16 to see how much the write pulse setting has changed, then the variation in edge shift to be detected calculates to be approximately 6.3% (= 1/16) per step.

Also, the predetermined amount of variation is more preferably set to be smaller than the calculated value with potential measurement errors taken into account.

And if has been decided in Step S905 that the 2T signal level adjustment be made, the fifth processing step S903 is carried out. Otherwise, the write pulse adjustment ends.

The variation in edge shift with the write pulse setting for use in the processing step S905 is more preferably what has been detected with the write pulse setting changed in the previous 2T mark adjustment processing step S904. In that case, the edge shift variation to retain should be at least associated with the write pulse setting that has been finally selected as a result of the 2T mark adjustment.

Then there is no need to perform the read/write operation for detecting the edge shift variation in the processing step S905. As a result, the time it takes to get the write adjustment done and the recording space to use (in the case of a write-once optical disc) can be both saved.

As described above, if has been decided in Step S905 that the 2T signal level adjustment be made, the fifth processing step S903 is carried out. Otherwise, the write pulse adjustment ends.

In the fifth processing step S903, the 2T signal level is adjusted. By making this 2T signal level adjustment, the lengths of recorded marks can be adjusted so as to fall within the range in which the 2T mark adjustment can be done in the processing step S904.

And then by performing the 2T mark adjustment processing step S904 all over again, the 2T marks, on which the write adjustment has failed in the first attempt, can also be appropriately adjusted this second time around.

As described above, according to the processing method shown in FIG. 9B, the 2T signal level adjustment is made only when necessary according to the result of the 2T mark adjustment. That is why the 2T signal level adjustment can be omitted when not necessary, and therefore, the time it takes to get the write adjustment done and the recording space to use (in the case of a write-once optical disc) can be both saved eventually.

Also, as the edge shift or β value to be used as a target value in the processing step S903, the edge shift that has been detected in the 3T mark adjustment processing step S902 or the β value that has been measured while the edge shift is being detected in that processing step is preferably used. In that case, the edge shift or the β value to retain is at least associated with the write pulse setting that has been finally selected as a result of the 3T mark adjustment.

Then, there is no need to perform the read/write operation for detecting either the edge shift or the β value as the target value (i.e., the processing steps S501 through S505 shown in FIG. 5) in the processing step S903. As a result, the write operation to be performed in the processing step S903 can be simplified. Consequently, the time it takes to get the write adjustment done and the recording space to use (in the case of a write-once optical disc) can be both saved.

In the examples described above, the “long marks” are supposed to be 4T or longer recorded marks. But the long marks may also be 5T or longer marks or even 6T or longer marks. In that case, however, a write pulse adjustment should be done separately. For example, if the long marks are supposed to be 5T or longer marks, a write pulse adjustment should be made separately on 4T marks. And the write pulse adjustment on the 4T marks can get done in the same way as the write pulse adjustment on the 3T marks described above.

As described above, the signal level adjustment can be used as a part of the processing for determining write pulse settings for multiple recorded marks. Alternatively, the signal level adjustment may also be carried out by itself, and may even be performed no matter whether the lengths of recorded marks are beyond the optical diffraction limit or not. For example, the signal level adjustment may be made on 3T marks as pre-processing for the processing step S902.

According to the signal level adjustment of the preferred embodiment described above, the second recording pattern is written under multiple writing conditions and then the areas on which the write operation has been performed under those conditions on a one by one basis are scanned. However, the read/write operation may be performed a number of times using each of those writing conditions.

Also, in the preferred embodiment described above, an evaluation index value for a read signal, from which DC offset components have been removed, is measured with respect to an A/D converted digital read signal. Alternatively, before the A/D conversion is made, an analog circuit may remove the DC offset components from an analog read signal accurately. And then the evaluation index value may be measured for the read signal that has been digitized by A/D conversion.

Furthermore, in the preferred embodiment described above, the first recording pattern is supposed to include no shortest marks or spaces. However, the first recording pattern may also include some shortest marks and spaces as long as the frequencies of appearance of those shortest marks and spaces are so much lower than those of the other marks and spaces that the influence caused by those shortest marks and spaces is negligible.

Furthermore, in the preferred embodiment described above, the signal level adjustment is made using the β value. However, the β value may be replaced with a binarized signal obtained by performing PRML read signal processing and the amplitude of a read signal associated with that binarized signal.

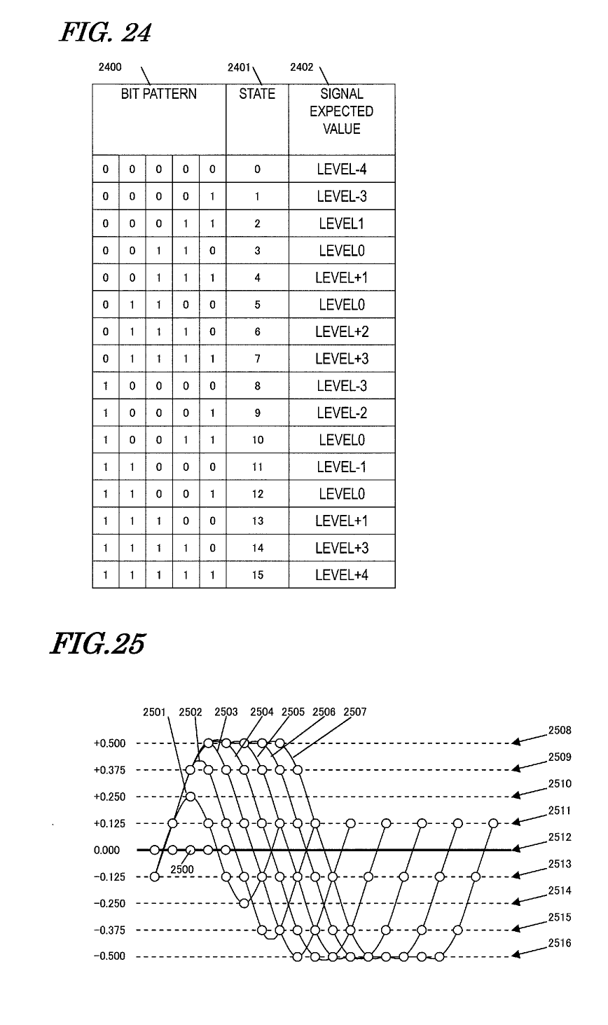

FIG. 24 is a table showing expected values for use in the maximum likelihood decoding process in a situation where the PR equalization section 8 shown in FIG. 18 has PR (1, 2, 2, 2, 1) equalization characteristic.

Specifically, FIG. 24 shows the levels 2402 of signal expected values with respect to the bit patterns 2400 of binarized data representing 5T marks or spaces. As for a BD, for example, the 1-7 PP modulation is adopted, and therefore, the shortest marks and spaces have a length of 2T and there are 32 different bit patterns 2400 representing 5T marks or spaces. However, if patterns including 1T marks or spaces are removed from those 32 patterns, then only 16 patterns will be left as indicated by the states 2401 in FIG. 24. And if these 16 different bit patterns 2400 are convoluted with the PR (1, 2, 2, 2, 1) frequency characteristic, nine levels of 0 through 8 will be produced. The signal expected values 2402 represent those nine levels by values of −4 through +4 with the center level 4 supposed to be zero.

FIG. 25 shows ideal 2T through 9T read signals based on the bit patterns 2400 and the signal expected values 2402 obtained in FIG. 24. Specifically, the signals 2500, 2501, 2502, 2503, 2504, 2505, 2506 and 2507 represent 2T, 3T, 4T, 5T, 6T, 7T, 8T and 9T waveforms, respectively. The signal levels 2508, 2509, 2510, 2511, 2512, 2513, 2514, 2515 and 2516 represent signal expected value levels of +4, +3, +2, +1, 0 (i.e., the center level), −1, −2, −3 and −4, respectively.

The bit pattern 2400 may be determined by the waveform of the binarized signal. And based on the bit pattern thus determined, the actual signal level of the read signal, which corresponds to any of the levels shown in FIG. 25, can be detected.

That is to say, in making the signal level adjustment, the first and second recording patterns are written, and each signal level value is detected by the read signal obtained. That is why either the absolute value of any of these signal levels or the correlation between multiple signal levels in combination may be used as the index value for newly making the signal level adjustment.

### Embodiment 2

As in the first preferred embodiment described above, the lengths of some recorded marks are supposed to be at or beyond the optical diffraction limit according to the writing condition of this second preferred embodiment. Also, just like the first preferred embodiment described above, only 2T recorded marks and spaces are at or beyond the optical diffraction limit. However, the present invention is in no way limited to this specific preferred embodiment.

Hereinafter, a third recording pattern for use in this second preferred embodiment will be described.

In adjusting writing condition for a mark with a predetermined recording length, the write adjustment section 102 writes a recording pattern, from which marks that are longer than the predetermined recording length by one recording unit length and/or marks that are shorter than the predetermined recording length by one recording unit length are removed, on the information recording medium and adjusts a writing condition for recording such marks with the predetermined recording length.

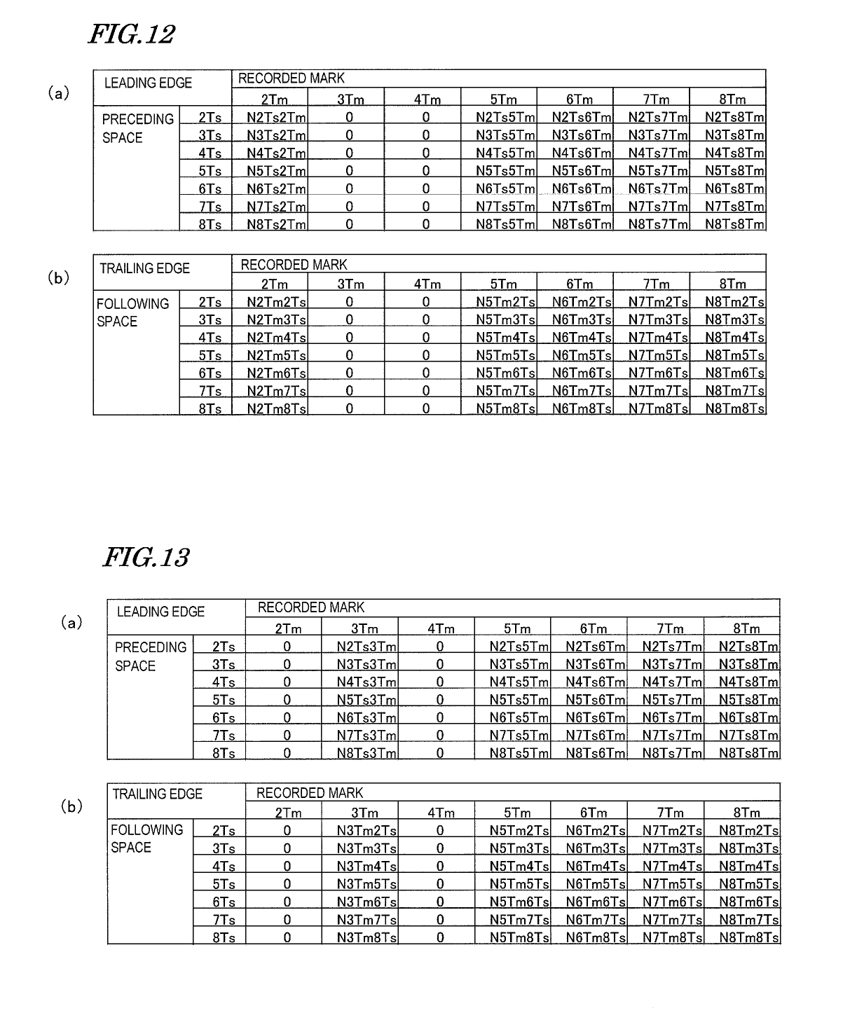

For example, in adjusting a writing condition for recording a 2T mark, the write adjustment section 102 writes a recording pattern from which 3T marks have been removed (see FIG. 11). FIG. 11 shows a recording pattern that does include a 2T mark and 4T through 8T marks but that does not include any 3T mark. Alternatively, the recording pattern may also be a pattern from which not only the 3T mark but also a 4T mark, which is longer than the 2T mark by two recording unit lengths, have been removed as shown in FIG. 12.

Also, in adjusting a writing condition for recording a 3T mark, the write adjustment section 102 writes a recording pattern that does include a 3T mark and 5T through 8T marks but that does not include any 2T or 4T mark (see FIG. 13).

FIG. 11 shows the frequencies of appearance of the third recording pattern that does not include recorded marks, of which the lengths are different from that of the shortest mark by 1T. Since the shortest mark of this preferred embodiment is a 2T mark, the recording pattern shown in FIG. 11 is a recording pattern including no 3T marks. FIG. 11(a) shows the frequencies of appearance at the leading edge, and FIG. 11(b) shows the frequencies of appearance at the trailing edge.

As described above, when a high-density write operation is performed so that the lengths of marks recorded are at or beyond the optical diffraction limit, the edge detection patterns could be detected erroneously. Nevertheless, a recorded mark to be detected erroneously often has a length that is only one step off the target one (i.e., a recorded mark, of which the length is just 1T longer or shorter than the correct one), and the mark recorded rarely has a length that is different from the intended one by 2T or more. Such a recorded mark, of which the length is just 1T longer or shorter from that of the recorded mark to be adjusted, will be referred to herein as a “recorded mark of a proximate length”.

According to this preferred embodiment, write pulse settings for a target recorded mark are adjusted using a recording pattern in which such recorded marks of a proximate length never appear (such as the third recording pattern). In a situation where the recorded mark to adjust is the shortest mark, even if no edge detection pattern for the shortest mark has been detected but if an edge detection pattern for a 3T mark has been detected, it can be seen that the shortest mark has actually been recorded in too large a size. Also, as for the shortest marks, if their frequencies of appearance are compared to each other on a space-by-space basis, it can also be seen that the shortest marks have actually been recorded in too small a size. This is because even if the marks detected have the same length of 2T, their edges may have been detected with respect to spaces of different lengths as already described with reference to portion (d) of FIG. 21.

Also, the third recording pattern is preferably a recording pattern in which the frequencies of appearance of all marks are even. This is preferred in order to control read clock pulses with stability and detect accurately signal index values associated the write pulse settings for all recorded marks other than the shortest ones when the write pulse adjustment is carried out on the shortest marks.

Furthermore, if adjustment needs to be done on the shortest marks first of all in a situation where initial write pulse settings are adopted for every recorded mark, either a random signal in which the shortest marks and spaces are weighted with the frequency of appearance or a random signal to be written as a part of user data is preferably used. This is because in that case, the shortest marks define a write signal reference length with respect to all marks.

Furthermore, if the second shortest recorded marks (i.e., 3T recorded marks) have not been adjusted yet and have been formed in too small a size, those marks could provide an edge detection pattern about the shortest marks. That is why if recorded marks of the proximate length have not been adjusted yet, it is preferred that such recorded marks of the proximate length never appear.

The third recording pattern is preferably a random signal that has been subjected to the DSV control. This is particularly preferred in a situation where edge shifts detected by maximum likelihood decoding are used to adjust write pulse settings because the coefficients of an adaptive equalization filter can be converged with good stability in that case.

FIG. 12 shows the frequencies of appearance of a fourth recording pattern, which is preferable to the third recording pattern. Specifically, FIG. 12(a) shows the frequencies of appearance at the leading edge, and FIG. 12(b) shows the frequencies of appearance at the trailing edge.

In the fourth recording pattern, 3T marks never appear as in the third recording pattern described above and neither does 4T mark. This is because if 4T marks were recorded shorter than expected, then those marks would be detected erroneously to be 3T marks and it would be difficult to tell such a situation from a different situation where 2T marks have been recorded longer than expected. For example, if the 2T mark expanded in 4Ts2Tm or if the 4T mark shrank in 2Ts4Tm, both of those recorded marks would be detected to be a pattern 3Ts3Tm.

It should be noted that according to the present invention, such a recording pattern in which 3T marks never appear does not always have to be used when the shortest marks are adjusted. For example, when write pulse adjustment is made on 3T marks, a recording pattern in which recorded marks of the proximate length never appear may be used for the 3T marks as shown in FIG. 13. In the recording pattern shown in FIG. 13, neither 2T marks nor 4T marks, of which the lengths are 1T shorter or longer than that of the 3T marks to be adjusted, appear. Specifically, FIG. 13(a) shows the frequencies of appearance at the leading edge, and FIG. 13(b) shows the frequencies of appearance at the trailing edge.

As described above, according to this preferred embodiment, write pulse adjustment is made on the recorded marks using a recording pattern (such as the ones shown in FIGS. 11 to 13) in which recorded marks that are at least 1T longer than the recorded marks to be subjected to the write pulse adjustment and/or recorded marks that are at least 1T shorter than such recorded marks never appear.

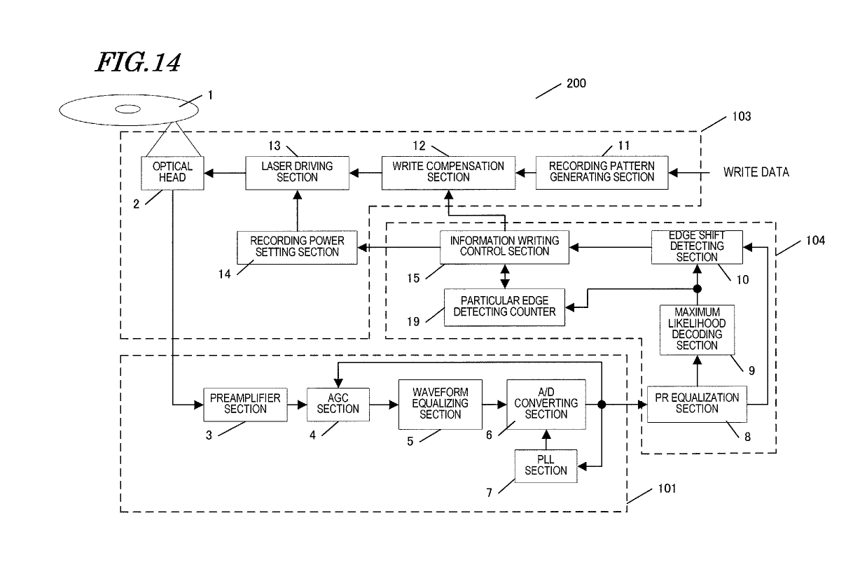

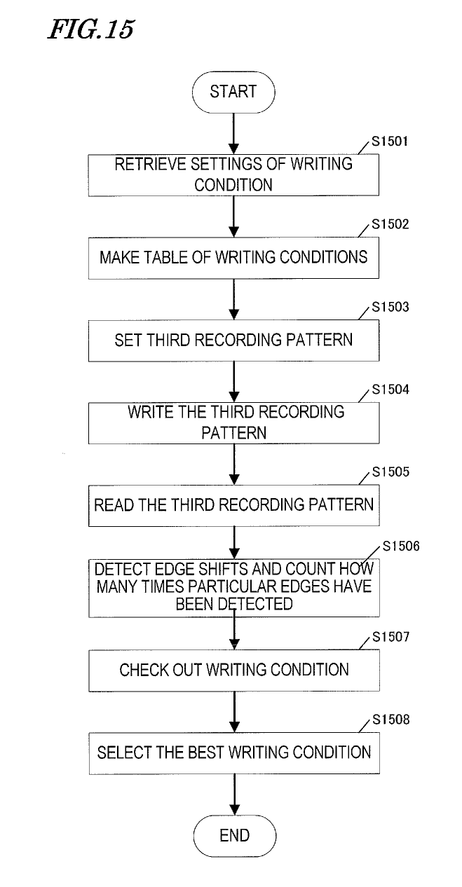

Hereinafter, it will be further described with reference to FIG. 14 exactly how the processing of this preferred embodiment is carried out. FIG. 14 illustrates an information reading and writing apparatus 200 as a specific preferred embodiment of the present invention.

This information reading and writing apparatus 200 includes the reading section 101, the write adjustment section 104 and the writing section 103.

The reading section 101 and the writing section 103 have the same configurations as their counterparts of the information reading and writing apparatus 100 described above.

The write adjustment section 104 includes the PR equalization section 8, the maximum likelihood decoding section 9, the edge shift detecting section 10, the information writing control section 15 and a particular edge detecting counter 19. The configuration of this apparatus is obtained by adding the particular edge counter 19 to the reading and writing apparatus shown in FIG. 18.

The information writing control section 15 controls the writing section 103 so that a write signal, including at least one recorded mark of which the length will be at or beyond the optical diffraction limit that is defined as one of optical conditions for the optical head 2 (including the wavelength of the laser beam and NA), is written on the information recording medium. In this case, the recording pattern to be written may be one of the recording patterns of this preferred embodiment (e.g., the third recording pattern).

The particular edge detecting counter 19 receives not just a binarized signal from the maximum likelihood decoding section 9 but also information about the frequencies of appearance of the recording pattern (or preferably only non-appearing edge patterns) and about the lengths of recorded marks to be subjected to write pulse adjustment from the information writing control section 15.

Also, the particular edge detecting counter 19 determines the non-appearing edge patterns by reference to the information about the frequencies of appearance and counts how many times those non-appearing edges have been detected from the binarized signal.

Furthermore, the particular edge detecting counter 19 also counts how many times the edges of recorded marks of a particular length, which are supposed to be subjected to the write pulse adjustment, have been detected. It should be noted that the number of edges is preferably counted only for the shortest marks.

It should be noted that the “particular edges” of this preferred embodiment refer to those non-appearing edges and the edges of recorded marks of a particular length that are supposed to be subjected to the write pulse adjustment.

And the particular edge detecting counter 19 outputs the edge patterns detected and their count to the information writing control section 15.

It will be further described how this information reading and writing apparatus 200 operates. In the following example, among various write pulse settings (i.e., write parameters) of the shortest 2T marks, their pulse width Ttop (which will be identified herein by “Ttop2T”) is supposed to be adjusted. However, the write pulse setting adjustment may also be done on their recording power, not on their write pulse width.

FIG. 15 is a flowchart showing the procedure in which the reading and writing apparatus 200 of this preferred embodiment adjusts write pulse settings.

Hereinafter, the write pulse setting adjustment procedure will be described step by step with reference to FIG. 15. That write pulse setting adjustment procedure is carried out by the information reading and writing apparatus 200 on the information recording medium 1.

The first through fifth processing steps S1501 through S1505 are the same as their counterparts shown in FIG. 5, and a detailed description thereof will be omitted herein.

In the first processing step S1501, settings of the writing condition are retrieved.

The processing carried out in this Step S1501 is the same as what is performed in Step S501 shown in FIG. 5.

Next, in the second processing step S1502, a table of writing conditions is made.

This processing step S1502 is equivalent to the processing step S506 shown in FIG. 5.

Then, in the third processing step S1503, a third recording pattern is set.

What should be done in this processing step S1503 is almost the same as what needs to be done in the processing step S507 shown in FIG. 5. Nevertheless, it is the third recording pattern that should be set in this processing step, which is a difference between this preferred embodiment and the preferred embodiment described above.

Subsequently, in the fourth processing step S1504, the operation of writing the third recording pattern on the information recording medium 1 is carried out.

What should be done in this processing step S1504 is almost the same as what needs to be done in the processing step S508 shown in FIG. 5. Nevertheless, it is the third recording pattern that should be written in this processing step, which is a difference between this preferred embodiment and the preferred embodiment described above.

Thereafter, in the fifth processing step S1505, the operation of reading the third recording pattern, which has been written under multiple writing conditions, is carried out.

What should be done in this processing step S1505 is almost the same as what needs to be done in the processing step S509 shown in FIG. 5. Nevertheless, it is the third recording pattern that should be read in this processing step, which is a difference between this preferred embodiment and the preferred embodiment described above. Also, in this preferred embodiment, a digital signal, which has had its DC offset components removed, is supplied to the PR equalization section 8.

Then, in the sixth processing step S1506, edge shifts associated with multiple writing conditions are detected and it is also counted how many times a particular edge has been detected.

The digital signals associated the multiple writing conditions are subjected to PRML read signal processing using the PR equalization section 8 and the maximum likelihood decoding section 9 in combination. The waveform shaped digital read signal and the binarized signal are respectively output from the PR equalization section 8 and the maximum likelihood decoding section 9 to the edge shift detecting section 10, which detects the edge shifts in response.

The equalization characteristic of the PR equalization section 8 may be PR (1, 2, 2, 2, 1) equalization, for example, and the maximum likelihood decoding section 9 may be a Viterbi decoder, for example.

Meanwhile, the particular edge detecting counter 19 receives not just the binarized signal from the maximum likelihood decoding section 9 but also information about the frequencies of appearance of the recording pattern and about the lengths of recorded marks to be subjected to write pulse adjustment from the information writing control section 15, and counts how many times a particular edge has been detected.

The edge shifts and the count are supplied to the information writing control section 15.

Then, in the seventh processing step S1507, each of the writing conditions is checked out to see if it satisfies a particular criterion.

The recording pattern that has been set in the processing step S1503 is the third recording pattern in which 3T marks never appear.

That is why first of all, the information writing control section 15 confirms the count of 3T marks that has been provided by the particular edge detecting counter 19.

If the count of 3T marks is found to be greater than the predetermined value that has been set in advance based on the frequency of appearance of the third recording pattern (e.g., if the count is greater than 30% of the frequency of appearance of the recorded marks to be subjected to the write adjustment), then the information writing control section 15 decides that the shortest marks have been recorded in too large a size. In that case, the edge shifts that have been detected using such a writing condition will not be used as indices for making write pulse adjustment.

On the other hand, if the writing condition has resulted in a count that is equal to or smaller than the predetermined value, then the information writing control section 15 confirms, on a space-by-space basis, the count of 2T marks themselves to be subjected to the write adjustment.

If the count of 2T marks that have been detected in all spaces is different on average from the frequency of appearance of the third recording pattern by a predetermined value (e.g., 30%) or more, then the information writing control section 15 decides that the shortest recorded marks have been formed in too small a size. In that case, the edge shifts that have been detected under such a writing condition will not be used as indices for making write pulse adjustment.

It should be noted that if the shortest recorded mark were smaller than expected, then such a mark could be detected as a part of a space, not the mark itself. That is why it would be more effective to make a decision by not just comparing the frequencies of appearance to each other but also checking out the numerical value of edge shifts as well. Also, instead of letting the 2T marks appear in all spaces, the 2T marks may be made to appear only in particular spaces (which may be either odd spaces such as 3T, 5T and 7T spaces or even spaces). Then, the decision can be made more easily.

Furthermore, if the recorded marks to be subjected to the write adjustment are larger than the shortest marks, then a recording pattern shown in FIG. 13, in which a recorded mark of a proximate length never appears on either side of the recorded mark to be subjected to the write adjustment, is preferably used.

Finally, in the eighth processing step S1508, the best writing condition is selected.

The information writing control section 15 determines the best writing condition by the edge shifts associated with the writing conditions that have turned out to satisfy the criterion in Step S1507.

Specifically, in this case, the information writing control section 15 selects a write pulse setting that will result in the same edge shift as the target edge shift that is stored either inside the information recording medium or inside the information reading and writing apparatus.

As described above, the particular edge detecting counter counts the number of a first kind of edges detected in a read signal representing a mark with the predetermined recording length and/or the number of a second kind of edges detected in a read signal representing a mark that is not included in the recording pattern. And the particular edge detecting counter invalidates the signal index value that has been obtained under a writing condition that makes the number of the first kind of edges detected equal to or smaller than a predetermined value and/or a writing condition that makes the number of the second kind of edges detected equal to or greater than the predetermined value. The predetermined value may be determined by the frequency of appearance of the predetermined recording length in the recording pattern.

As described above, according to this preferred embodiment, write pulse adjustment is made on target recorded marks (particularly recorded marks, of which the lengths are at or beyond the optical diffraction limit) by using a recording pattern, from which recorded marks that are at least 1T longer than the target ones and/or recorded mark that are at least 1T shorter than the target ones have been removed.

As a result, a writing condition, which will get the target recorded marks of the write adjustment recorded in too large or too small a size, can be removed, and therefore, the writing conditions can be adjusted more accurately.

Also, even if recorded marks, which are adjacent to the target recorded mark of the write adjustment, were recorded in too large or too small a size and would interfere with the target recorded mark of the write adjustment, the index value for the write adjustment (e.g., the edge shift in this preferred embodiment) could also be detected without being affected by the interference. As a result, the writing conditions can be adjusted more accurately.

The processing procedure of the preferred embodiment of the present invention described above does not always have to be carried out in the order described above but may be performed in any other order as long as each and every one of the processing steps described above is included there. Optionally, the present invention could be implemented as a read/write program that is defined to enable the reading and writing apparatus of the preferred embodiment described above to perform its functions fully. In that case, the read/write program may be pre-installed in the information reading and writing apparatus 100 of the preferred embodiment described above. Specifically, the read/write program could be stored in advance in some recording means (such as a memory) of the information reading and writing apparatus just before it is shipped. Alternatively, the read/write program could also be stored in some recording means after the reading and writing apparatus has been shipped. For example, the user may get the read/write program downloaded from a particular website on the Internet with or without making a payment and then get that downloaded program installed in his or her reading and writing apparatus. Or if the read/write program is stored in a computer readable information recording medium such as a flexible disc, a CD-ROM, a DVD-ROM or whatever, then the read/write program could be installed in an information reading and writing apparatus using an input device. In that case, the read/write program installed will be stored in some recording means.

It should be noted that the information recording medium of the preferred embodiment of the present invention described above does not have to be an optical disc such as a CD, a DVD or a BD but may also be a magneto-optical recording medium such as an MO (magneto-optical disc). In any case, the present invention is applicable to any information recording medium from which a signal wave with signal amplitude varying with the length of consecutive recording code (i.e., zeros or ones) of a digital signal can be retrieved.

Furthermore, part of the reading and writing apparatus of the present invention could be provided as a single-chip LSI (as a form of a semiconductor integrated circuit) or a circuit component that functions as a device for adjusting writing conditions (such as a write pulse waveform) in order to write information on an information recording medium. For example, the write adjustment section 102 or 104 could be fabricated as an LSI and used as a writing condition adjuster. If a part of the reading and writing apparatus is fabricated as a single-chip LSI, the signal processing to adjust the write parameters can be done in much shorter time. Optionally, respective parts of the reading and writing apparatus could be fabricated as LSIs independently of each other.

### INDUSTRIAL APPLICABILITY

The present invention can be used particularly effectively in the field of recorders/players (such as BD drives and BD recorders) for performing read/write operations on various kinds of information recording media (such as BD-Rs, BD-REs and other information recording media) by writing data with a laser beam or electromagnetic force and other information devices.

### REFERENCE SIGNS LIST

1 information recording medium
2 optical head
3 preamplifier section
4 AGC section
5 waveform equalizing section
6 A/D converting section
7 PLL section
8 PR equalization section
9 maximum likelihood decoding section
10 edge shifting section
11 recording pattern generating section
12 write compensation section
13 laser driving section
14 recording power setting section
15 information writing control section
16 DC control section
17 evaluation index measuring section
18 index target value storage section
19 particular edge detecting counter
100, 200 information reading/writing apparatus
101 reading section
102, 104 write adjustment section
103 writing section
201 peak power
202 bottom power
203 cooling power
204 space power
205 extinction level
600 adder
601 integrator
602 gain circuit

1. A writing condition adjusting apparatus for adjusting a writing condition for use to write information on an information recording medium,
the apparatus comprising a control section for controlling the value of adjustment to be made on the writing condition using first and second recording patterns, the first recording pattern being used to adjust a writing condition for recording marks and spaces, of which the lengths are equal to or longer than a predetermined recording length, the second recording pattern being used to adjust a writing condition for recording marks and spaces, of which the lengths are shorter than the predetermined recording length by one recording unit length,
wherein the control section performs a first write adjustment for adjusting the writing condition for recording marks, of which the lengths are shorter by one recording unit length, and
wherein the control section decides whether or not the writing condition that has been determined as a result of the first write adjustment needs to be adjusted again, and
wherein on deciding that the writing condition be adjusted again, the control section sets a signal index value, which has been defined based on the first recording pattern, to be a target value, and
wherein the control section performs a second write adjustment for adjusting again the writing condition for recording marks, of which the lengths are shorter by one recording unit length, so that a signal index value associated with the one-unit-shorter marks becomes as close to the target value as possible.

2. The writing condition adjusting apparatus of claim 1, wherein the marks, of which the lengths are shorter by one recording unit length, have lengths that are either at or beyond an optical diffraction limit, and
wherein the marks, of which the lengths are equal to or longer than the predetermined recording length, have lengths that are still under the optical diffraction limit.

3. The writing condition adjusting apparatus of claim 1, wherein the marks, of which the lengths are shorter by one recording unit length, have lengths with a spatial frequency of 1.0 or more, and
wherein the marks, of which the lengths are equal to or longer than the predetermined recording length, have lengths with a spatial frequency of less than 1.0.

4. The writing condition adjusting apparatus of claim 1, wherein the marks and spaces, of which the lengths are shorter by one recording unit length, have such lengths that make the amplitude of a read signal equal to zero in an interval in which there is a series of those marks and spaces that are shorter by one recording unit length.

5. The writing condition adjusting apparatus of claim 1, wherein the signal index value is a β value, and
wherein in either the first or second recording pattern, a number of combinations of marks and spaces, of which the lengths are equal to or longer than the predetermined recording length, have frequencies of appearance that are equal to each other.

6. The writing condition adjusting apparatus of claim 1, wherein the signal index value is an edge shift detected by maximum likelihood decoding, and
wherein in a number of combinations of marks and spaces, of which the lengths are equal to or longer than the predetermined recording length, in either the first or second recording pattern, combinations of marks and spaces with the predetermined recording length have the highest frequency of appearance.

7. The writing condition adjusting apparatus of claim 1, wherein in a group of combinations of marks and spaces, of which the lengths are equal to or longer than the predetermined recording length, each of multiple combinations in the first recording pattern has as high a frequency of appearance as its counterpart in the second recording pattern.

8. The writing condition adjusting apparatus of claim 1, wherein in the second recording pattern, a combination of the marks and spaces, of which the lengths are shorter by one recording unit length, has the highest frequency of appearance.

9. The writing condition adjusting apparatus of claim 1, wherein the first recording pattern corresponds to a random signal, and
wherein the second recording pattern includes, in combination, a random signal corresponding to a combination of marks and spaces, of which the lengths are equal to or longer than the predetermined recording length, and a single signal corresponding to the marks and spaces, of which the lengths are shorter by one recording unit length.

10. The writing condition adjusting apparatus of claim 1, wherein the control section decides, by any of the writing condition that has been determined as a result of the first write adjustment, a β value, a frequency of appearance, and the amount of edge shift with a variation in write pulse settings, whether or not the writing condition needs to be adjusted again.

11. The writing condition adjusting apparatus of claim 1, wherein before making the first write adjustment, the control section performs a third write adjustment for adjusting a writing condition for recording marks with the predetermined recording length using the first recording pattern, and
wherein the target value is either an edge shift or a β value that is associated with the writing condition that has been determined as a result of the third write adjustment.

12. The writing condition adjusting apparatus of claim 1, wherein the marks, of which the lengths are shorter by one recording unit length, are the shortest marks.

13. The writing condition adjusting apparatus of claim 1, wherein the lengths Tm and Ts of the shortest marks and spaces to be recorded on the information recording medium satisfy (Tm+Ts)<λ/(2×NA), where λ represents the wavelength of a laser beam for use to perform a write operation on the information recording medium and NA represents the numerical aperture of an objective lens.

14. The writing condition adjusting apparatus of claim 13, wherein the laser beam has a wavelength λ of 400 nm to 410 nm.

15. The writing condition adjusting apparatus of claim 13, wherein the objective lens has a numerical aperture NA of 0.84 to 0.86.

16. The writing condition adjusting apparatus of claim 13, wherein the sum Tm+Ts of the length Tm of the shortest marks and the length Ts of the shortest spaces is less than 238.2 nm.

17. A method for adjusting a writing condition for use to write information on an information recording medium, the method comprising the steps of:
controlling the value of adjustment to be made on the writing condition using first and second recording patterns, the first recording pattern being used to adjust a writing condition for recording marks and spaces, of which the lengths are equal to or longer than a predetermined recording length, the second recording pattern being used to adjust a writing condition for recording marks and spaces, of which the lengths are shorter than the predetermined recording length by one recording unit length;
performing a first write adjustment for adjusting the writing condition for recording marks, of which the lengths are shorter by one recording unit length;
deciding whether or not the writing condition that has been determined as a result of the first write adjustment needs to be adjusted again;
on deciding that the writing condition be adjusted again, setting a signal index value, which has been defined based on the first recording pattern, to be a target value, and
performing a second write adjustment for adjusting again the writing condition for recording marks, of which the lengths are shorter by one recording unit length, so that a signal index value associated with the one-unit-shorter marks becomes as close to the target value as possible.

18. An information reading and writing apparatus comprising:
a reading section for generating a digital signal based on an analog signal representing information that has been retrieved from an information recording medium;
a write adjustment section for adjusting a writing condition for use to write information on the information recording medium by reference to a signal index value that the write adjustment section has detected by itself from either the analog signal or the digital signal; and
a writing section for writing information on the information recording medium under that writing condition,
wherein the write adjustment section includes a writing control section for controlling the value of adjustment to be made on the writing condition using first and second recording patterns, the first recording pattern being used to adjust a writing condition for recording marks and spaces, of which the lengths are equal to or longer than a predetermined recording length, the second recording pattern being used to adjust a writing condition for recording marks and spaces, of which the lengths are shorter than the predetermined recording length by one recording unit length,
wherein the write adjustment section performs a first write adjustment for adjusting the writing condition for recording marks, of which the lengths are shorter by one recording unit length, and
wherein the write adjustment section decides whether or not the writing condition that has been determined as a result of the first write adjustment needs to be adjusted again, and
wherein on deciding that the writing condition be adjusted again, the write adjustment section sets a signal index value, which has been defined based on the first recording pattern, to be a target value, and
wherein the write adjustment section performs a second write adjustment for adjusting again the writing condition for recording marks, of which the lengths are shorter by one recording unit length, so that a signal index value associated with the one-unit-shorter marks becomes as close to the target value as possible.

19. An information reading and writing method comprising:
a reading step for generating a digital signal based on an analog signal representing information that has been retrieved from an information recording medium;
a write adjustment step for adjusting a writing condition for use to write information on the information recording medium by reference to a signal index value that has been detected from either the analog signal or the digital signal; and
a writing step for writing information on the information recording medium under that writing condition,
wherein the write adjustment step includes the steps of:
controlling the value of adjustment to be made on the writing condition using first and second recording patterns, the first recording pattern being used to adjust a writing condition for recording marks and spaces, of which the lengths are equal to or longer than a predetermined recording length, the second recording pattern being used to adjust a writing condition for recording marks and spaces, of which the lengths are shorter than the predetermined recording length by one recording unit length;
performing a first write adjustment for adjusting the writing condition for recording marks, of which the lengths are shorter by one recording unit length;
deciding whether or not the writing condition that has been determined as a result of the first write adjustment needs to be adjusted again;
on deciding that the writing condition be adjusted again, setting a signal index value, which has been defined based on the first recording pattern, to be a target value; and
performing a second write adjustment for adjusting again the writing condition for recording marks, of which the lengths are shorter by one recording unit length, so that a signal index value associated with the one-unit-shorter marks becomes as close to the target value as possible.

20. An information reading and writing apparatus comprising:
a reading section for generating a digital signal based on an analog signal representing information that has been retrieved from an information recording medium;
a write adjustment section for adjusting a writing condition for use to write information on the information recording medium by reference to a signal index value that the write adjustment section has detected by itself from either the analog signal or the digital signal; and
a writing section for writing information on the information recording medium under that writing condition,
wherein in adjusting a writing condition for recording marks with a predetermined recording length, the write adjustment section writes, on the information recording medium, a recording pattern that does not include marks, of which the lengths are longer than the predetermined recording length by one recording unit length, and/or marks, of which the lengths are shorter than the predetermined recording length by one recording unit length.

21. The information reading and writing apparatus of claim 20, wherein the predetermined recording length is 2T, and
wherein in adjusting a writing condition for recording 2T marks, the write adjustment section writes a recording pattern, which includes no 3T marks, on the information recording medium.

22. The information reading and writing apparatus of claim 20, wherein the recording pattern does not include marks, of which the lengths are longer than the predetermined recording length by two recording unit lengths, either.

23. The information reading and writing apparatus of claim 22, wherein the predetermined recording length is 2T, and
wherein in adjusting a writing condition for recording 2T marks, the write adjustment section writes a recording pattern, which includes neither 3T marks nor 4T marks, on the information recording medium.

24. The information reading and writing apparatus of claim 20, wherein the recording pattern includes marks, of which the lengths are longer than the predetermined recording length by two or more recording unit lengths.

25. The information reading and writing apparatus of claim 24, wherein the predetermined recording length is 2T, and
wherein in adjusting a writing condition for recording 2T marks, the write adjustment section writes a recording pattern, which does include the 2T marks and 4T through 8T marks but which includes no 3T marks, on the information recording medium.

26. The information reading and writing apparatus of claim 24, wherein the predetermined recording length is 3T, and
wherein in adjusting a writing condition for recording 3T marks, the write adjustment section writes a recording pattern, which does include the 3T marks and 5T through 8T marks but which includes neither 2T marks nor 4T marks, on the information recording medium.

27. The information reading and writing apparatus of claim 20, wherein the write adjustment section further includes a particular edge detecting counter for counting the number of a first kind of edges detected in a read signal representing a mark with the predetermined recording length and/or the number of a second kind of edges detected in a read signal representing a mark that is not included in the recording pattern,
wherein the write adjustment section invalidates the signal index value that has been obtained under a writing condition that makes the number of the first kind of edges detected equal to or smaller than a predetermined value and/or a writing condition that makes the number of the second kind of edges detected equal to or greater than a predetermined value.

28. The information reading and writing apparatus of claim 27, wherein the predetermined value is determined by the frequency of appearance of the predetermined recording length in the recording pattern.
